(19) United States
(12) Patent Application Publication
(10) Pub. No.: US 2020/0070774 A1
(43) Pub. Date: Mar. 5, 2020

(54) ASSEMBLY, SYSTEM AND METHOD OF AN ELECTRONIC WHEEL LOCKING ASSEMBLY (BOOT) WITH WIRELESS UNLOCKING

(71) Applicant: Cimmino-Cotona Partnership, Brooklyn, NY (US)

(72) Inventors: Alberto Sid, Upper Saddle River, NJ (US); Amit Sid, Ridgewood, NJ (US); Dean Reiter, Stony Point, NY (US); Robert Cimmino, Staten Island, NY (US)

(21) Appl. No.: 16/613,059

(22) PCT Filed: May 11, 2018
(86) PCT No.: PCT/US2018/032362

§ 371 Date: Nov. 12, 2019

Related U.S. Application Data
(60) Provisional application No. 62/505,051, filed on May 11, 2017.

(51) Int. Cl. B60R 25/09; B60R 25/104; B60R 25/10; B60R 25/24; H04W 12/04

(52) U.S. Cl. CPC B60R 25/09; B60R 25/104; B60R 25/1004; H04W 84/12; H04W 12/04; B60R 2025/1013; B60R 2325/101; B60R 25/24

(57) ABSTRACT

Assemblies and methods for selectively locking a vehicle wheel having an outer assembly engaging wheel outside and an inner assembly engaging the wheel inside, the assembly having an outer transverse member protruding inward and an inner transverse member protruding outward that are slidably coupled together providing a variable transverse length, the reduction of the length providing for the securing of the wheel by the assembly and the expansion providing the release, the expansion and reduction being controlled by a electronic motor and gear assembly which is responsive to a controller that receives an input to lock the wheel and a transceiver over which a user input passcode is received, that if such user input passcode is a valid security code, the assembly automatically expands and unlocks the assembly from the wheel.

### CROSS-REFERENCE TO RELATED APPLICATIONS

This application claims the benefit of U.S. Provisional Application No. 62/505,051, filed on May 11, 2017.

### FIELD

The present disclosure relates to assemblies and methods for temporarily locking a wheel of a vehicle to prevent movement of the vehicle, and more specifically, to a assemblies and method of selectively attaching a locking boot for temporarily securing to the wheel to prevent movement of the vehicle until the user of the vehicle receives authorization to remove the wheel locking assembly.

### BACKGROUND

The statements in this section merely provide background information related to the present disclosure and may not constitute prior art.

Generally, an illegally parked vehicle has been traditionally issued a summons, towed or secured in its place until the owner of the vehicle pays the required illegal parking fees or fines. In recent years, the use of a wheel securing “boot” has often been utilized where the vehicle can be left in the illegal parking location and there is no need to tow the vehicle from that location. Typically these wheel locking assemblies prevent the wheel from rolling and prevent the wheel from being removed from the vehicle. Such boots include those described in U.S. Pat. Nos. 7,988,046; 7,731,088; 9,154,436; and U.S. Publications 2015/0239429; and 2006/078739, by way of example.

The present wheel locking assemblies requires that the parking personnel place the arms of the boot on either side of the wheel and to physically and mechanically compress or collapse the two arms towards the wheel that utilizes a latching or ratchet locking mechanism for locking the two arms in a locked and secured position about the wheel. Such locking means are not typically compressed on the wheel but merely collapsed about the wheel such the inner side is within the inner portion of the wheel and the outer side is about one or more of the lug nuts holding on the wheel. The secured wheel locking assemblies is attached but is not secured under pressure to the wheel.

The present wheel locking assemblies also requires that the car owner pays the required fine and the car owner or tow truck operator or parking administrator obtains a pass key. The car owner or wheel boot representative such as a tow truck operator or parking administrator then enters the received pass key into a user keypad of the wheel boot assembly. The wheel boot assembly compares the received pass key to see if it is the correct pass key or code, and if so, then disables the latthing or ratcheting lock assembly thereby enable the person to pull the outer arm of the boot away from the wheel thereby open and releasing the boot from the wheel thereby enabling the car owner to selectively remove the wheel boot from the wheel and then move the vehicle.

While the present wheel locking assemblies enable a person such as the car owner or wheel boot representative to obtain the access code, such systems require that a code be manually entered into a user interface on the wheel boot. These wheel locking assemblies are often near the ground and under the vehicle and are susceptible to bad weather such as snow and ice which makes them difficult to get to in order to enter the user access code. Further, the current wheel locking assemblies are manually closed and opened by manual manipulation of the inner and/or outer locking members that secure the sides of the wheel.

### SUMMARY

The inventors hereof have succeeded at designing improved vehicle wheel locking assemblies and methods that, among other benefits, includes an improved system and method for enabling the placement of the wheel locking assembly onto a wheel that is to be secured through the use of an automated locking system that motor driven when an lock input is entered via a locking button that will secure the wheel locking assembly about the wheel. As this is automated. In some embodiments the assembly is secured to the wheel with an amount of securing force that is consistent and secure from use to use thereby ensuring proper placement without the operator having to manually manipulate the securing members to the wheel. In this manner, the operator can more quickly and easily secure the wheel of the vehicle that is low and near the ground within less effort.

Further, once attached, the inventor's systems and methods as described herein will enable the vehicle's user to obtain an unlocking access code, and to enter the unlock access code via a mobile device that is wirelessly communicating with a wireless interface of the wheel locking assembly without requiring the user to have to manually enter the unlocking access code on a user interface on the wheel locking assembly. In this manner, by way of example, the vehicle's user can obtain the unlocking access code from the parking authority, establish a wireless communication using their own mobile phone or device with the wheel locking assembly, enter the code, and if the unlocking access code that is entered and received by the wheel locking assembly over the wireless interface is the correct unlocking code, the wheel locking assembly would automatically disengage from the wheel to which it was locking. The person would also not need to manually mechanically manipulate or pull apart the two sides of the wheel locking assembly, but rather the wheel locking assembly would fully release and disengage itself from the wheel and the person would only then need to pick up the disengaged wheel locking assembly that falls to the ground about the wheel. This makes it easier for unlocking as these wheel locking assemblies are often near the ground and under the vehicle and may be in snow or ice. Further, the wheel locking assembly and its use as developed by the inventors includes a manual unlocking override wherein the boot assembly can be disengaged from a locked wheel by use of a security key that does not require or use the wireless interface or the motorized unlocking system and method that is used by a person having to enter a security code using their mobile device. These represent considerable improvements over prior versions of vehicle wheel locking or booting systems and their methods of use.

According to one aspect, an assembly is provided for selectively locking a wheel of an automotive vehicle having an outer assembly for engaging the outer portion of the wheel and an inner assembly for engaging the inner portion of the wheel and an inner assembly for engaging the inner portion of the wheel. The assembly includes the outer assembly that is selectively coupled to the inner assembly. The outer assembly has an outer transverse member protruding inward and has an outer transverse member length that is slidably coupled to an inner transverse member protruding outward and having an inner transverse member length. As coupled, they form a transverse member overlap having an overlap length. The coupling includes a slidable engaging fixtures and a locking bar rotatably coupled to the outer assembly and to the inner assembly. The assembly also includes a local power supply, a motor powered by the local power supply and a bi-directional gear drive mechanism engaged with the motor and with the rotatable locking bar. The controller, the motor and the bi-directional gear drive are configured to rotate the locking bar responsive to the rotation of the motor in a clockwise direction and a counterclockwise direction. The locking bar is rotatably coupled to the outer assembly in a fixed position and rotatably coupled to a locking bar receiver of the inner assembly for varying the transverse member overlap and the overlap length and a total transverse member length formed by the slidably coupling of the inner transverse member and outer transverse member responsive to the rotation of the locking bar by the motor and the gear drive mechanism.

According to another aspect, an assembly is provided for selectively locking a wheel of an automotive vehicle having an outer assembly for engaging the outer portion of the wheel and an inner assembly for engaging the inner portion of the wheel and an inner assembly for engaging the inner portion of the wheel. The assembly includes the inner assembly that has an inner wheel clamping member and an inner transverse member and the outer assembly having an outer assembly main housing, an outer wheel clamping member and an outer transverse member slidably coupled to the inner transverse member. The outer assembly also includes a power supply, a controller with a processor and a non-transitory non-volatile memory, computer executable instructions and at lease one unlock code stored in the memory, and a wireless transceiver. The outer assembly also include an electronic lock selectively coupling the outer transverse member of the outer assembly to the inner transverse member of the inner assembly at a plurality of different positions for varying a transverse member overlap formed by the coupling of the inner transverse member with the outer transverse member and an overlap length of the transverse member overlap and a total transverse member length formed by the slidably coupling of the inner transverse member and outer transverse member responsive to the electronic lock. The wireless transceiver and the motor are each operatively coupled to the controller. The wireless transceiver is configured by computer executable code and its interconnections to the various component systems described herein for receiving a user code from a remote wireless device wherein the controller is configured by computer executable code and its interconnections to the various component systems described herein for comparing the received user code with stored unlock code and generating an unlock command responsive to a successful comparing. The electronic lock is responsive to the unlock command and enabling the varying of the transverse length of the combined inner and outer transverse members to expand a distance between the outer wheel clamping member and the inner wheel clamping member enabling the removal of the assembly from the wheel.

According to yet another aspect, an assembly is described that provides for selectively locking a wheel of an automotive vehicle with the assembly having outer and inner assemblies. The outer assembly is configured to engage the outer portion of the wheel and the inner assembly is configured to engage the inner portion of the wheel. The he inner assembly being coupled to the outer assembly by a selectable variable locking mechanism controlled by a locking controller having a wireless transceiver for communicating with a remote unlocking device for receiving an unlock code over the wireless interface. The outer assembly has an outer assembly main housing, an outer wheel clamping member including a wheel hub nut cover that is dimensioned for covering one or more wheel lug nuts of the wheel, and an outer transverse member. The main housing of the outer assembly includes a power supply, a controller, and a user interface coupled to the controller for receiving a lock input from a user. It also includes a memory storing computer executable instructions and at least one unlock code, and a wireless transceiver. A motor is provided that is operable with a locking bar having a first end rotatably mounted in the outer assembly and selectively rotatable by a gear assembly coupled to the motor. The inner assembly has an inner wheel engagement member that includes an inner wheel clamping member that engages an inner portion of the wheel. The inner assembly also includes an inner transverse member configured for slidable engagement with the outer transverse member of the outer assembly for varying a transverse length of the combined inner and outer transverse members. The inner transverse member includes a locking bar receiver for receiving a variable portion of the second end of the locking bar such that the transverse length of the combined transverse member length (lengths of the inner and outer transverse members as coupled) varies with the rotation of the locking bar by the gear assembly motor driven by the motor. The inner transverse member is selectively coupled to the inner wheel clamping member by a manual locking assembly wherein when the manual locking assembly is unlocked, with the inner wheel clamping member being therefrom manually separable from the inner transverse member.

The assembly controller is configured by computer executable code and its interconnections to the various component systems described herein to receiving the lock input from the user interface and to generate an assembly lock motor command to the motor. The motor is coupled directly or indirectly through one or more additional electrical components to the controller so that the motor is responsive to the lock motor command and through the gear box rotating the locking bar contracts the transverse length of the combined inner and outer transverse members to reduce the distance between the outer wheel clamping member and the inner wheel clamping member. The controller generates a transverse length reduction command to the motor and the motor and gear assembly rotates the locking bar in response thereto. The wireless transceiver and the motor are each operatively coupled to the controller with the wireless transceiver configured to receive a user code from a remote wireless device, compare the received user code with stored unlock code and generate an unlock motor expansion command to the motor responsive to a successful comparing of the two codes. The motor is responsive to the unlock motor command and through the gear box rotates the locking bar to expand the transverse length of the combined inner and outer transverse members to expand the distance between the outer wheel clamping member and the inner wheel clamping member enabling the removal of the assembly from the wheel.

According to another aspect, an assembly is provided for selectively locking a wheel of an automotive vehicle. The assembly includes an outer assembly fur engaging the outer portion of the wheel and an inner assembly for engaging the inner portion of the wheel. The inner assembly is coupled to the outer assembly through an assembly that includes a selectable variable locking mechanism controlled by a locking controller having a wireless transceiver for communicating with a remote unlocking device for receiving an unlock code therefrom. The outer assembly has an outer assembly main housing, an outer wheel clamping member including a wheel hub nut cover dimensioned for covering one or more wheel lug nuts of the wheel, and an outer transverse member. The main housing includes a power supply, a controller, a user interface coupled to the controller for receiving a lock input from a user, a memory storing computer executable instructions and at least one unlock code, and a wireless transceiver. The assembly includes is a motor with an operationally coupled locking bar that has a first end rotatably mounted in the outer assembly and selectively rotatable by a gear assembly coupled to the motor.

The inner assembly has an inner wheel engagement member including an inner wheel clamping member to engage an inner portion of the wheel and an inner transverse member configured for slidable engagement with the outer transverse member of the outer assembly for varying a transverse length of the combined inner and outer transverse members. The inner transverse member includes a locking bar receiver for receiving a variable portion of the second end of the locking bar and the transverse length varies with the rotation of the locking bar by the gear assembly motor driven by the motor and thereby varies the length of the combined transverse member. The inner transverse member is selectively coupled to the inner wheel clamping member by a manual locking assembly that when unlocked, the inner wheel clamping member is manually separable from the inner transverse member independent of the traverse member, the motor and the coupled locking bar. The inner transverse member includes a base member dimensioned for slidable transverse engagement with the outer transverse member for forming the combined transverse member. The inner transverse member includes an inner foundation member selectably secured to the base member by a manual locking mechanism. The inner wheel clamping member is fixedly mounted to the inner foundation member when the inner foundation member is selectably secured to the base member by the manual locking mechanism and becomes completely disengaged from the base member when the manual locking mechanism is activated by a user and the inner foundation member is thereby removable front the selective securement from the base member.

The controller is configured by computer executable code and its interconnections to the various component systems described herein to receive the lock input from the user interface and generate an assembly lock motor command to the motor. The motor is responsive to the lock motor command and, through the gear box rotating the locking bar, to contract the transverse length of the combined inner and outer transverse members to reduce the distance between the outer wheel clamping member and the inner wheel clamping member. The controller generates a transverse length reduction command to the motor and the motor and gear assembly rotating the locking bar in response thereto. The wireless transceiver and the motor are each operatively coupled to the controller with the wireless transceiver configured for receiving a user code from a remote wireless device, the controller configured for comparing the received user code with stored unlock code and generating an unlock motor expansion command to the motor responsive to a successful comparing. The motor is responsive to the unlock motor command and, through the gear box rotating the locking bar, to expand the transverse length of the combined inner and outer transverse members to expand a distance between the outer wheel clamping member and the inner wheel clamping member enabling the removal of the assembly from the wheel.

According to yet another aspect, a method of operating an automotive vehicle wheel locking assembly includes the steps of receiving at a first data interface of the assembly at least one unlock code, and storing the received at least one unlock code in a memory of the assembly. The method then includes receiving at a user interface of the boot a lock input and generating by a controller an assembly lock motor command to a motor of the assembly responsive to receiving of the lock input. The method then includes operating the motor in a first direction and responsive thereto, rotating a locking bar in a first direction, the operating being responsive to the generating of the lock motor command and responsive to the locking bar rotating in the first direction, slidably moving an inner transverse member in the direction towards an outer transverse member contracting or reducing a combined transverse member length defined by the lengths of the inner and outer transverse members and reducing a wheel locking distance defined between an outer wheel clamping member associated with the outer transverse member and an inner wheel clamping member associated with the inner transverse member and placing the assembly in a wheel locked state.

The method then includes that following the placement of the assembly in the wheel locking state, receiving over a second data interface an unlock code input from a user and comparing the received unlock input with the memory stored at least one unlock code. The method also includes generating an unlock motor expansion command to the motor responsive to a successful comparing, operating the motor in a first direction responsive to the generated unlock motor expansion command, and rotating the locking bar in a second direction. The method further includes that in response to the locking bar rotating in the second direction, slidably moving the inner transverse member in the direction away from the outer transverse member expanding the combined transverse member length and expanding the wheel locking distance and placing the assembly in a wheel unlocked state.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIGS. 1A, 1B, 1C, 1D, 1E and 1F are various images of a wheel lock assembly according to a first exemplary embodiment.

FIG. 2 is a schematic block diagram of operational components of a wheel lock assembly according various exemplary embodiments.

FIGS. 3A and 3B are images of an outer assembly of a wheel lock assembly according to one exemplary embodiment.

FIGS. 4A, 4B, 4C and 4D are images of an inner assembly of a wheel lock assembly according to one exemplary embodiment.

FIGS. 5A and 5B are illustrations of a motor drive assembly for a wheel lock assembly according to one exemplary embodiment.

FIG. 6A, 6B, and 6C are illustrations of one method of operating one embodiment of a wheel lock assembly.

FIG. 7A, 7B, 7C, 7D and 7E are illustrations of another method of operating one embodiment of a wheel lock assembly.

FIG. 8 is a flow chart illustrating a process flow of engaging a wheel lock assembly onto a wheel according to one exemplary embodiment.

FIG. 9 is a flow chart illustrating a process flow of wireless unlocking of the wheel lock assembly from a wheel according to one exemplary embodiment.

FIG. 10 is a flow chart illustrating a process flow for manually disengaging a wheel lock assembly from a prior locked wheel according to one exemplary embodiment.

FIG. 11 is a flow chart illustrating various wheel lock sensing and controlling features according to various embodiments of the wheel lock assembly.

FIG. 12 an exemplary controller system and environment for a wheel lock assembly according to one exemplary embodiment.

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses.

According to one embodiment, an assembly is provided for selectively locking a wheel of an automotive vehicle having an outer assembly for engaging the outer portion of the wheel and an inner assembly for engaging the inner portion of the wheel and an inner assembly for engaging the inner portion of the wheel. The assembly includes the outer assembly that is selectively coupled to the inner assembly. The outer assembly has an outer transverse member protruding inward and has an outer transverse member length that is slidably coupled to an inner transverse member protruding outward and having an inner transverse member length. In some embodiments, the distal or outward end of the outer transverse member engages with the proximal end of the inner transverse member in a slidable arrangement such as one engaging with the other having a slightly different diameter so that one fits within the other, and can include, coupling fixtures such as tongues and groves or similar engagement features at ends or along one or both of their transverse lengths. As coupled, the inner transverse member and the outer transverse member form a transverse member length that includes both of their individual lengths reduced by the variable amount of the slidable overlap between the two that is an overlap length. As noted, the coupling between the two can include a slidable engagement fixture and a locking bar rotatably coupled in a fixed position to the outer assembly and rotatably engaged with the inner transverse member of the inner assembly.

The assembly also includes a local power supply that is typically a battery, a motor powered by the local power supply and a bi-directional gear drive mechanism engaged with the motor and with the rotatable locking bar. The controller, the motor and the bi-directional gear drive are configured to rotate the locking bar responsive to the rotation of the motor in a clockwise direction and a counterclockwise direction. The locking bar is rotatably coupled to the outer assembly in a fixed position and rotatably coupled to a locking bar receiver of the inner assembly for varying the transverse member overlap and the overlap length and a total transverse member length formed by the slidably coupling of the inner transverse member and outer transverse member responsive to the rotation of the locking bar by the motor and the gear drive mechanism.

In some embodiments thereof, the outer assembly has an outer wheel clamping member and the inner assembly has an inner wheel clamping member. The inner wheel clamping member is selectively attachable to the inner transverse member. In such an embodiment, this can include the inner transverse member having separable portions or components of the inner wheel clamping member, one being an inner transverse foundation member and the other being a selectively attachable and removable inner vertical member. The removable inner vertical member can include an inner wheel clamping support member that engages the inner portion of the wheel and the inner vertical transverse base member that attaches to the inner transverse foundation member of the inner transverse member that engages the outer transverse member. The inner vertical member having the inner clamping member that forms the inner foundation member is selectively attached to the inner transverse base member about the distal end of the inner transverse member portion of the inner transverse foundation member by a manual lock or locking assembly that selectively fixedly secures the removable inner vertical member including its inner wheel clamping member and the inner wheel foundation member from the inner transverse base member that when coupled form the inner transverse member and the collectively the inner assembly.

In some embodiments, the assembly includes a controller with a processor and a non-transitory non-volatile memory that stores computer executable instructions and at lease one unlock code for the wheel assembly. Unlike prior art wheel locking assemblies, the current wheel locking assembly includes a wireless transceiver operatively coupled to the controller with both being configured to receive over the wireless interface a user code from a remote wireless device. This can be in addition to having a local keypad or can be in alternative to the wheel lock assembly having to have a keypad for receiving a user input unlock code. The controller includes computer executable instructions that compares the received user input code with at least one of the unlock codes that is stored in the memory. If the user input code matches or is the same as a valid unlock code as stored in the memory, the controller generates an unlock command directly or indirectly to the motor. The motor is operationally coupled to an unlocking mechanism such as a locking bar. This operational coupling can include a bi-directional gear drive mechanism by way of example. The unlocking bar can include a rotating bar such as threaded rod or screw rod that when rotated either expands or contracts the distance between the outer assembly and the inner assembly. In such embodiments, when the unlock code matches, the locking bar is responsive to the unlock command sent to the motor and rotates to expand the total transverse length of the assembly to expand a distance between the outer wheel clamping member and the inner wheel clamping member enabling the removal of the assembly from the wheel.

In some embodiments, the controller is configured by computer executable code and its interconnections to the various component systems described herein to receive a user lock input to generate an assembly lock command to the motor. The receipt of the lock command can be via the wireless interface or could be by receiving a lock activation sequence or input such as by a user pressing a lock button on the assembly. This could also be by means of receiving an input over a wired data interface or an input from a keypad or graphical user interface on the assembly if such is provided in that embodiment. When the lock input is received, the controller generates a lock command that is sent directly or indirectly to the motor and the motor is responsive to the lock command and rotates in the proper direction to rotate the locking bar into a locked position. The motor can be coupled to the locking bar by the bi-directional gear drive mechanism. The locking bar when so rotated cooperates with the inner and the outer transverse members to reduce the total transverse length of the combined transverse member to reduce the distance between the outer wheel clamping member and the inner wheel clamping member.

In some embodiments, the assembly also includes a transverse length sensor that is positioned to detect the total transverse length, or a portion thereof such as a maximum length of the total transverse length when unlocking the assembly or a predetermined collapsed minimum allowable length when reducing the total transverse length when locking the assembly about a wheel. The sensed position of the length, such as may be detected by the locking bar or the relationship of the locking bar to a portion of the inner transverse member, is provided to the controller as a detection of the transverse length. The controller controls the operation of the motor to expand and to reduce the total transverse length responsive to the detection of the position.

In some embodiments, the assembly includes a transverse reduction pressure sensor that is configured to detect an amount of pressure applied during the reduction or collapsing process of the transverse member that collapses the outer assembly and the inner assembly for locking about the wheel. In this case, the transverse reduction pressure sensor detects an amount of pressure that is being applied by the wheel lock assembly during the reduction of the transverse member length and transmits the detected pressure to the controller. The controller is configured by computer executable code and its interconnections to the various component systems described herein to monitor and/or compare the detected pressure with a predetermined maximum allowable reduction pressure and then to terminate the generation of the transverse length reduction command to the motor responsive to the detection of the predetermined maximum allowable reduction pressure being achieved.

In some embodiments, the assembly includes a tamper sensor arrangement that is aimed to identify tampering or attempted tampering of the wheel lock assembly after placement of the wheel lock assembly onto a wheel. In such embodiments, the assembly can include a motion sensor and/or an externally applied pressure sensor positioned on the assembly. The motion sensor can detect movements that are indicative of an attempt to remove the attached wheel lock device, or an applied instant force. The externally applied pressure sensor can be configured to detect an amount of external motion or external pressure being applied to the assembly when the assembly is in a locked mode such as an attempt to pull or force the outer assembly away from the wheel or away from the inner assembly. These tamper sensors are coupled to the controller that includes computer executable code and stored thresholds that when exceeded cause the controller to generate a command to an audio generator on the assembly such as an audible alarm or to generate a flashing visual indicator. The controller can be configured to receive the detected amount of the motion from the motion sensor, compare the received detected amount of motion to an alarm threshold motion threshold as stored in the memory, and to generate an audible and/or visual alarm over the audio generator responsive thereto. Additionally, in some embodiments, the detection of a tamper motion or force can result in the wheel lock boot from disabling its wireless interface, and in some embodiments the assembly is configured to transmit a tamper notification message over the wireless interface to a remote monitoring receiver and center such as a parking authority that may include an identification of the wheel lock assembly, its location and the vehicle identification or license plate or registration to which the wheel lock assembly is installed on a wheel. It should be understood to one of ordinary skill in the art that other embodiments as described herein can also be incorporated in this exemplary embodiment.

According to another embodiment, an assembly is provided for selectively locking a wheel of an automotive vehicle having an outer assembly for engaging the outer portion of the wheel and an inner assembly for engaging the inner portion of the wheel and an inner assembly for engaging the inner portion of the wheel. The assembly includes the inner assembly having an inner wheel clamping member and an inner transverse member and the outer assembly having an outer assembly main housing, an outer wheel clamping member and an outer transverse member slidably coupled to the inner transverse member. The outer assembly also includes a power supply, a controller with a processor and a non-transitory non-volatile memory, computer executable instructions and at lease one unlock code stored in the memory, and a wireless transceiver. In some embodiments, the controller is configured by computer executable code and its interconnections to the various component systems described herein to receive a user lock input to generate an assembly lock command to the electronic lock, the electronic lock responsive to the lock command and enabling a reduction in the transverse length of the combined inner and outer transverse members to reduce the distance between the outer wheel clamping member and the inner wheel clamping member.

The outer assembly also include an electronic lock selectively coupling the outer transverse member of the outer assembly to the inner transverse member of the inner assembly at a plurality of different positions for varying a transverse member overlap formed by the coupling of the inner transverse member with the outer transverse member and an overlap length of the transverse member overlap and a total transverse member length formed by the slidably coupling of the inner transverse member and outer transverse member responsive to the electronic lock. The wireless transceiver and the motor are each operatively coupled to the controller. The wireless transceiver is configured by computer executable code and its interconnections to the various component systems described herein for receiving a user code from a remote wireless device and the controller is configured by computer executable code and its interconnections to the various component systems described herein for comparing the received user code with stored unlock code and generating an unlock command responsive to a successful comparing. The electronic lock is responsive to the unlock command and enabling the varying of the transverse length of the combined inner and outer transverse members to expand a distance between the outer wheel clamping member and the inner wheel clamping member enabling the removal of the assembly from the wheel.

In some embodiments, the inner wheel clamping member is selectively attachable to the inner transverse member and in some such embodiments, a manual locking assembly selectively fixedly securing the inner wheel clamping member to the inner transverse member.

In some embodiments, the assembly also includes a transverse length sensor positioned to detect the total transverse length and coupled to the controller to provide a detection of the transverse length to the controller, the controller configured to control the operation of the electronic responsive to the detection.

In some embodiments, the assembly also includes a transverse reduction pressure sensor to detect an amount of pressure applied during the reduction process and provide the detected pressure to the controller, the controller configured to compare the detected pressure with a predetermined maximum pressure and to terminate the generation of the transverse length reduction command to the electronic lock responsive to the detection.

In some embodiments, the assembly can include a motion or pressure sensor positioned on the assembly configured to detect an amount of external motion or external pressure being applied to the assembly when the assembly is in a locked mode, the motion sensor coupled to the controller, and an audio generator operatively coupled to the controller. In some embodiments, the controller is configured by computer executable code and its interconnections to the various component systems described herein to receive the detected amount of the motion from the motion sensor, compare the received detected amount of motion to an alarm threshold motion threshold as stored in the memory, and to generate an audible alarm over the audio generator responsive thereto.

According to another exemplary embodiment, a wheel locking assembly is described that provides for selectively locking a wheel of an automotive vehicle with the assembly having outer and inner assemblies. The outer assembly is configured to engage the outer portion of the wheel and the inner assembly is configured to engage the inner portion of the wheel. The he inner assembly being coupled to the outer assembly by a selectable variable locking mechanism controlled by a locking controller having a wireless transceiver for communicating with a remote unlocking device for receiving an unlock code over the wireless interface. The outer assembly has an outer assembly main housing, an outer wheel clamping member including a wheel hub nut cover that is dimensioned for covering one or more wheel lug nuts of the wheel, and an outer transverse member. The main housing of the outer assembly includes a power supply, which in many cases is likely a common embodiment of a battery. Also included is a controller having one or more processors and possibly memory. Also included is a user interface coupled to the controller for receiving a lock input from a user. The assembly can also include a memory whether with the processor or separate, that stores computer executable instructions and at least one unlock code, and a wireless transceiver. The wireless transceiver can operate at any predetermined frequency or multiple frequencies and protocols and in some embodiments can include a mobile network, a satellite network, a Wi-Fi network, Bluetooth or Near Field Communication (NFC), by ways of example. The selection of such wireless transceiver and protocol would be based on the suitability and compatibility of the devices for which the assembly is design to allow for the receipt of a user input unlock code for potentially unlocking the wheel lock assembly. In sonic embodiments, the wireless transceiver is a Wi-Fi transceiver compliant with Wi-Fi industry standards, and the transceiver is configured by computer executable code and its interconnections to the various component systems described herein using encrypted messaging for receiving the unlock code.

In some embodiments, the wireless transceiver only communicates with a locally positioned mobile device using the Wi-Fi communication access point security certification protocol. In some embodiments, the outer assembly includes a user interface coupled to the controller to receive a manual wake-up input from a user and provides a wake-up instruction to the controller for activating the controller and the transceiver, with the transceiver being responsive thereto and wirelessly transmits the Wi-Fi access point security certification message prompting for entry of a Wi-Fi security key. In some embodiments, the wireless transceiver is configured by computer executable code and its interconnections to the various component systems described herein to receive a user Wi-Fi security key response to the Wi-Fi access point security certification message and provide the received security key as the user code to the controller responsive to the received Wi-Fi access point security certification message.

In some embodiments, the wireless transceiver is a Bluetooth transceiver compliant with Bluetooth standards, and in some embodiments the transceiver is configured by computer executable code and its interconnections to the various component systems described herein using encrypted messaging for receiving the user code. In some embodiments, the wireless transceiver only communicates with a locally positioned mobile device using the Bluetooth communication protocol. In some embodiments, the outer assembly includes a user interface coupled to the controller to receive a manual wake-up input from a user and provides a wake-up instruction to the controller for activating the controller and the transceiver. In some embodiments, the transceiver is configured to be responsive to the received wake-up instruction thereto and wirelessly transmit the Bluetooth secure simple pairing protocol prompting for input of a Bluetooth security key. In some embodiments, the wireless transceiver is configured by computer executable code and its interconnections to the various component systems described herein to receive user security key responsive to the Bluetooth secure simple pairing protocol prompt and provide the received user security key as the user code to the controller responsive.

A motor is operable at the direction of the controller and either directly or indirectly operates a locking bar that locks the outer assembly to the inner assembly and about the wheel. In some embodiments, the locking bar has a first end rotatable mounted in the outer assembly and selectively rotatable by a gear assembly coupled to the motor also mounted in the outer assembly. In some embodiments, the locking bar is a screw threaded bar and the base member includes a female threaded nut member fixedly mounted to an end plate of the base member on an end opposing an end having manual locking mechanism. The inner assembly has an inner wheel engagement member that includes an inner wheel clamping member that engages an inner portion of the wheel. The inner assembly also includes an inner transverse member configured for slidable engagement with the outer transverse member of the outer assembly for varying a transverse length of the combined inner and outer transverse members. The inner transverse member includes a locking bar receiver for receiving a variable portion of the second end of the locking bar such that the transverse length of the combined transverse member length (lengths of the inner and outer transverse members as coupled) varies with the rotation of the locking bar by the gear assembly motor driven by the motor. The inner transverse member is selectively coupled to the inner wheel clamping member by a manual locking assembly wherein when the manual locking assembly is unlocked, with the inner wheel clamping member being therefrom manually separable from the inner transverse member.

The assembly controller is configured by computer executable code and its interconnections to the various component systems described herein to receiving the lock input from the user interface and to generate an assembly lock motor command to the motor. The motor is responsive to the lock motor command and through the gear box rotating the locking bar contracts the transverse length of the combined inner and outer transverse members to reduce the distance between the outer wheel clamping member and the inner wheel clamping member. The controller generates a transverse length reduction command to the motor and the motor and gear assembly rotates the locking bar in response thereto. The wireless transceiver and the motor are each operatively coupled to the controller with the wireless transceiver configured to receive a user code from a remote wireless device, compare the received user code with stored unlock code and generate an unlock motor expansion command to the motor responsive to a successful comparing of the two codes. The motor is responsive to the unlock motor command and through the gear box rotates the locking bar to expand the transverse length of the combined inner and outer transverse members to expand the distance between the outer wheel clamping member and the inner wheel clamping member enabling the removal of the assembly from the wheel.

In some embodiments, the locking bar is a screw threaded bar. In such, embodiments, the motor and the gear drive assembly, such as a bi-directional gear drive assembly driven by the bi-directional motor, or interconnected assembly, rotates the screw threaded bar that rotates within the outer assembly and engages a threaded nut, such as a female threaded nut member that is fixedly mounted to an end plate of the inner transverse member such as in the proximal end of the inner transverse member. In this manner, the inner transverse member moves in and out as to the slidable engagement of the inner transverse member with the outer transverse member thereby varying the length of the total transverse member of the assembly.

In some embodiments, the motor and gear box are each bidirectional for rotating the screw threaded bar in two directions for reducing and expanding the transverse length, the controller including a processor and a bidirectional motor driver coupled between the processor and the motor for actuating and controlling the bidirectional operation of the motor. The user interface for receiving the lock input can be a switch a button in a simple form or can be more complex as in multiple buttons or a complete user interface.

In some embodiments, the inner transverse member includes a base member dimensioned for slidable transverse engagement with the outer transverse member for forming the combined transverse member, the inner transverse member including a inner clamp foundation member selectable secured to the base member by a manual locking mechanism, the inner wheel clamping member being fixedly mounted to the inner clamp foundation member when the inner clamp foundation member is selectable secured to the base member by the manual locking mechanism and being completely disengaged from the base member when the manual locking mechanism is activated by a user and the inner clamp foundation member is removed from selective securement from the base member. One embodiment of this is described above with regard to the prior embodiment and is incorporated herein as well. In some embodiments, the locking bar is a screw threaded bar and the base member includes a female threaded nut member fixedly mounted to an end plate of the base member on an end opposing an end having manual locking mechanism. In some embodiments, the manual locking mechanism is positioned at an outer end (referred also as the distal end) of the inner transverse member that is opposing an inner end (proximal end of the inner transverse member) that slidably engages with the outer transverse member.

In some embodiments, the transceiver and the controller are each further configured to receive the lock instruction as a lock code over the wireless transceiver from a remote wireless device. In other embodiments, the lock code or instructions can include an input by a user of a manipulation of a one or more buttons on the user interface. In one such embodiment, the user interface would comprise a s single button. The controller would received the lock instruction by the user pressing the single button a predetermined number of times or in a predetermined sequence or length of pressings. In other embodiments, this could include multiple buttons that are presses in an order that is predetermined for receiving the lock instruction and the controller is configured to compare the received button inputs with the stored lock code to determine if the lock code is received and to initiate the lock sequence and operation of the motor to lock the assembly. It should be noted that in some embodiments, the same one or more buttons can provide other inputs to the controller including the identification of a status message or lights such as the lighting of one or more LED lights that indicate one or more status of the assembly controller and the assembly operations, the level of the battery, as well as waking up the transceiver and initiating the transceiver to transmit a communication with a remote device as described herein. In some embodiments, a simplified user interface such as having on a single or two or more weather/water-proof sealed buttons on the assembly may be preferred from an ease of operation as well as a lower cost of manufacture, lower maintenance costs of not having to maintain a full user interface with a display and/or keyboard, and the like. This is one advantage of having the simplified button operation with a wireless interface for transmitting a request for a user to enter a user input code as the security pass code for initiating the unlocking of the wheel locking or boot assembly from the wheel.

As noted, in some embodiments, the user interface is configured by computer executable code and its interconnections to the various component systems described herein to receive a wake-up input from a user and provide wake-up instruction to the controller for activating the controller and the transceiver. In some embodiments, the user interface for the lock input is a different user interface than that for receiving the wake-up input from the user.

In some embodiments, the assembly also includes a transverse reduction limit detector positioned to detect the transverse length of the combined inner and outer transverse members and provide a detection of the reduced transverse length to the controller, the controller configured to terminate the generation of the transverse length reduction command responsive to the detection.

In some embodiments, the assembly also includes a transverse reduction pressure detector positioned to detect the pressure applied between the inner and outer transverse members during the reduction in the transverse length and to provide the detected pressure to the controller, the controller configured to terminate the generation of the transverse length reduction command responsive to the detection of the pressure that exceeds a predetermined reduction threshold as stored in the memory.

In some embodiments, the assembly also includes a transverse expansion limit detector positioned to detect the expanded transverse length of the combined inner and outer transverse members and provide a detection of the expanded transverse length to the controller, the controller configured to terminate the generation of the transverse length expansion command responsive to the detection.

In some embodiments, the controller includes a clock or tinier feature configured to place the controller and wireless transceiver in a sleep mode following that locking of the assembly about the automotive tire and following the unlocking of the assembly from the automotive tire.

In some embodiments, the controller includes a processor and a bidirectional motor driver coupled between the processor and the motor for actuating and controlling the bidirectional operation of the motor.

In some embodiments, the assembly includes a data interface including a data port coupled to the controller for communicating instructions with the controller from an external assembly control system coupled thereto.

In some embodiments, the memory includes non-volatile memory storing a single unlock code, and In some embodiments, the assembly includes a data interface port coupled to the controller and In some embodiments, the single unlock code is received by the controller through the data interface port and stored in at the nonvolatile memory until over written by receipt of a replacement unlock code as received by the controller over the data interface port.

In some embodiments, the non-volatile memory includes firmware that includes a single unlock code that is stored in the firmware that is used by the controller for comparison to the received user input code. Whether stored in firmware, or stored in another nonvolatile nontransitory memory, the stored unlock code or security code can be updated from time to time via a data interface with an external control system such as via a USB or similar data connection. In some embodiments, such can also be updated or changed using a wireless interface such as the wireless interface used for interfacing with a wireless device for receiving a user input code in an attempt to unlock the wheel lock assembly. In some embodiments, the controller includes a processor including non-volatile memory and in some embodiments, the computer executable instructions and the at least one unlock code are stored in the non-volatile memory.

In some embodiments, the assembly can also include a motion sensor positioned on the assembly configured to detect an amount of motion of the assembly when the assembly is in a locked mode, the motion sensor coupled to the controller, and an audio generator operatively coupled to the controller. In some embodiments, the controller is configured by computer executable code and its interconnections to the various component systems described herein to receive the detected amount of the motion from the motion sensor, compare the received detected amount of motion to an alarm threshold motion threshold as stored in the memory, and to generate an audible alarm over the audio generator responsive thereto.

In some embodiments, the assembly can also include a pressure sensor positioned on the assembly configured to detect an amount of pressure applied by an external force to the assembly when the assembly is in a locked mode, the pressure sensor being coupled to the controller, and an audio generator coupled to the controller, in some embodiments, the controller is configured by computer executable code and its interconnections to the various component systems described herein to receive the detected amount of the pressure from the motion sensor, compare the received detected amount of pressure to an alarm threshold pressure threshold as stored in the memory, and to generate an audible alarm over the audio generator responsive thereto.

In some embodiments, the outer assembly includes one or more visual indicators such as LEDs operatively coupled to the controller. In some embodiments, the controller and the visual indicators are configured to provide two or more operational states of the assembly.

In some embodiments, the outer assembly includes an audio generator operatively coupled to the controller. In some embodiments, the controller and the audio generator are configured to generate an audible indicator indicative of a state or a change of state of the assembly.

According to another embodiment, an assembly is provided to selectively locking a wheel of an automotive vehicle wherein the assembly includes an outer assembly for engaging the outer portion of the wheel and an inner assembly for engaging the inner portion of the wheel. The inner assembly is coupled to the outer assembly through an assembly that includes a selectable variable locking mechanism controlled by a locking controller having a wireless transceiver for communicating with a remote unlocking device for receiving an unlock code therefrom. The outer assembly has an outer assembly main housing, an outer wheel clamping member including a wheel hub nut cover dimensioned for covering one or more wheel lug nuts of the wheel, and an outer transverse member.

In some embodiments, the heel hub nut cover is configured and dimensioned to covering a center of the outer portion of the wheel including all of the wheel lug nuts. The main housing includes a power supply, a controller, a user interface coupled to the controller for receiving a lock input from a user, a memory storing computer executable instructions and at least one unlock code, and a wireless transceiver. Also includes is a motor with a coupled locking bar that has a first end rotatably mounted in the outer assembly and selectively rotatable by a gear assembly coupled to the motor.

The inner assembly has an inner wheel engagement member including an inner wheel clamping member to engage an inner portion of the wheel and an inner transverse member configured for slidable engagement with the outer transverse member of the outer assembly for varying a transverse length of the combined inner and outer transverse members. The inner transverse member includes a locking bar receiver for receiving a variable portion of the second end of the locking bar and the transverse length varies with the rotation of the locking bar by the gear assembly motor driven by the motor and thereby varies the length of the combined transverse member. The inner transverse member is selectively coupled to the inner wheel clamping member by a manual locking assembly that when unlocked, the inner wheel clamping member is manually separable from the inner transverse member independent of the traverse member, the motor and the coupled locking bar. The inner transverse member includes a base member dimensioned for slidable transverse engagement with the outer transverse member for forming the combined transverse member. The inner transverse member includes an inner clamp foundation member selectably secured to the base member by a manual locking mechanism. The inner wheel clamping member is fixedly mounted to the inner clamp foundation member when the inner clamp foundation member is selectably secured to the base member by the manual locking mechanism and becomes completely disengaged from the base member when the manual locking mechanism is activated by a user and the inner clamp foundation member is thereby removable from the selective securement from the base member.

The controller is configured by computer executable code and its interconnections to the various component systems described herein to receive the lock input from the user interface and generate an assembly lock motor command to the motor. The motor is responsive to the lock motor command and, through the gear box rotating the locking bar, to contract the transverse length of the combined inner and outer transverse members to reduce the distance between the outer wheel clamping member and the inner wheel clamping member. The controller generates a transverse length reduction command to the motor and the motor and gear assembly rotating the locking bar in response thereto. The wireless transceiver and the motor are each operatively coupled to the controller with the wireless transceiver configured for receiving a user code from a remote wireless device, the controller configured for comparing the received user code with stored unlock code and generating an unlock motor expansion command to the motor responsive to a successful comparing. The motor is responsive to the unlock motor command and, through the gear box rotating the locking bar, to expand the transverse length of the combined inner and outer transverse members to expand a distance between the outer wheel clamping member and the inner wheel clamping member enabling the removal of the assembly from the wheel.

In some embodiments, the manual locking mechanism is positioned at an outer end of the inner transverse member that is opposing an inner end that slidably engages with the outer transverse member.

Referring now to the Figures, a parts list is provided at the end of the specification for ease of review of the description of the Figures.

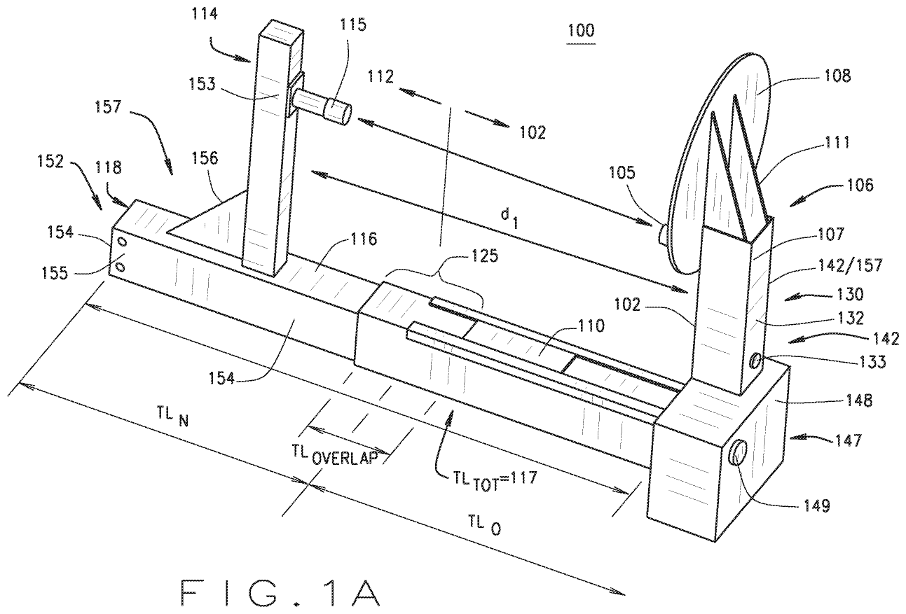

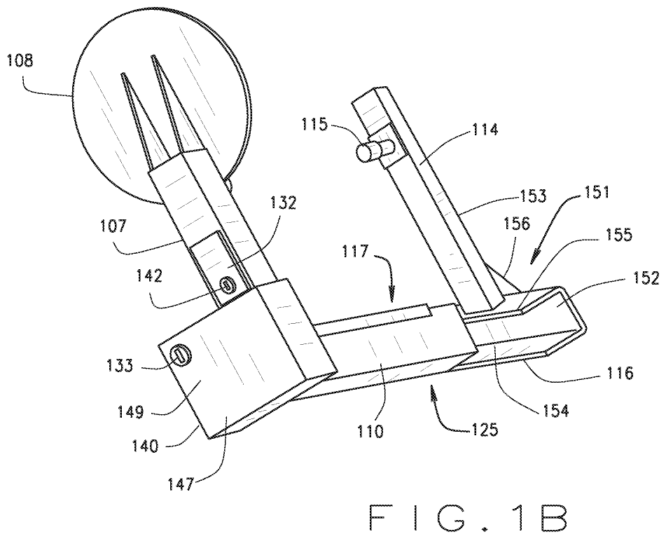

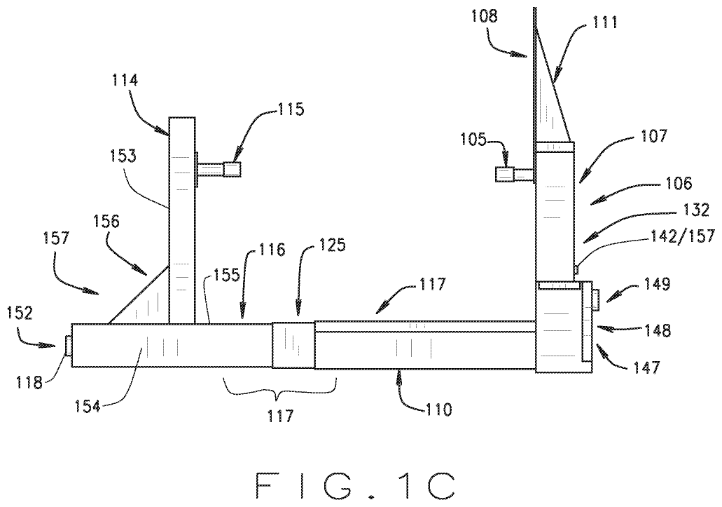

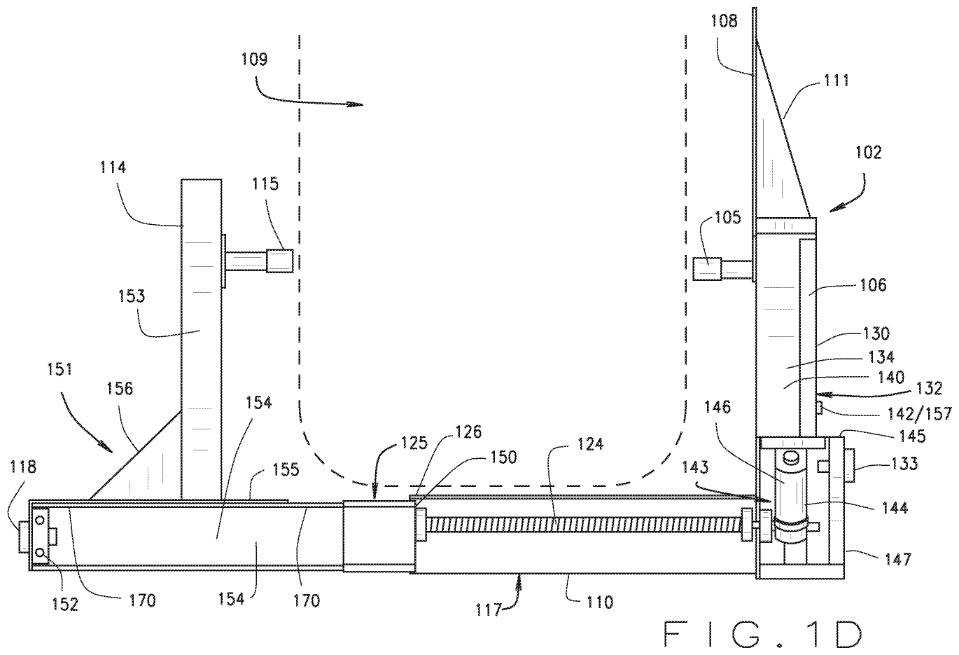

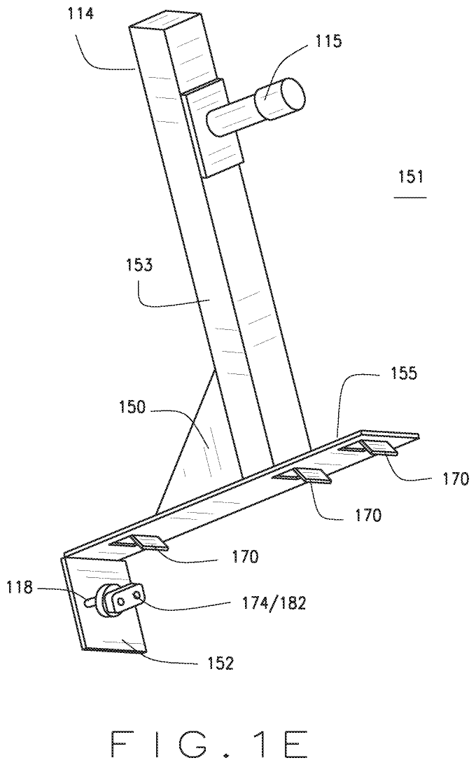

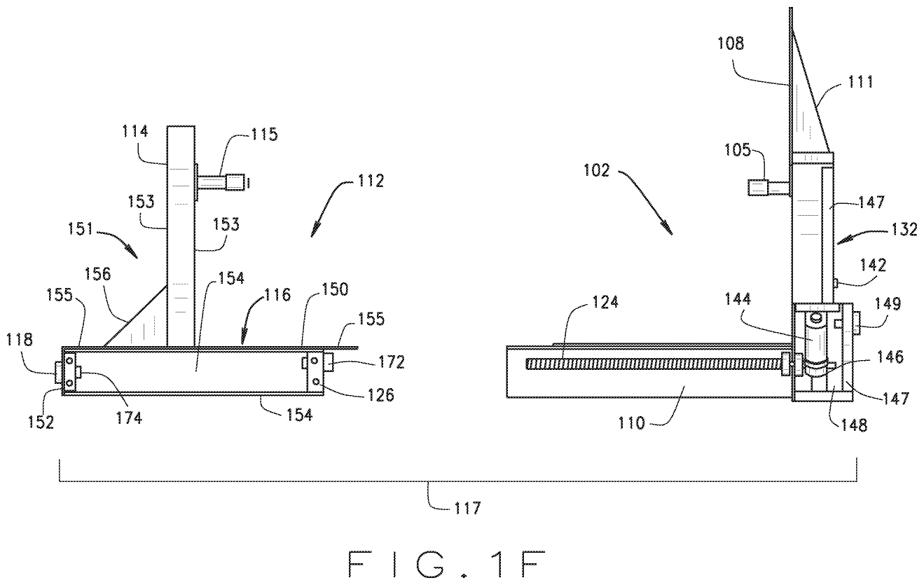

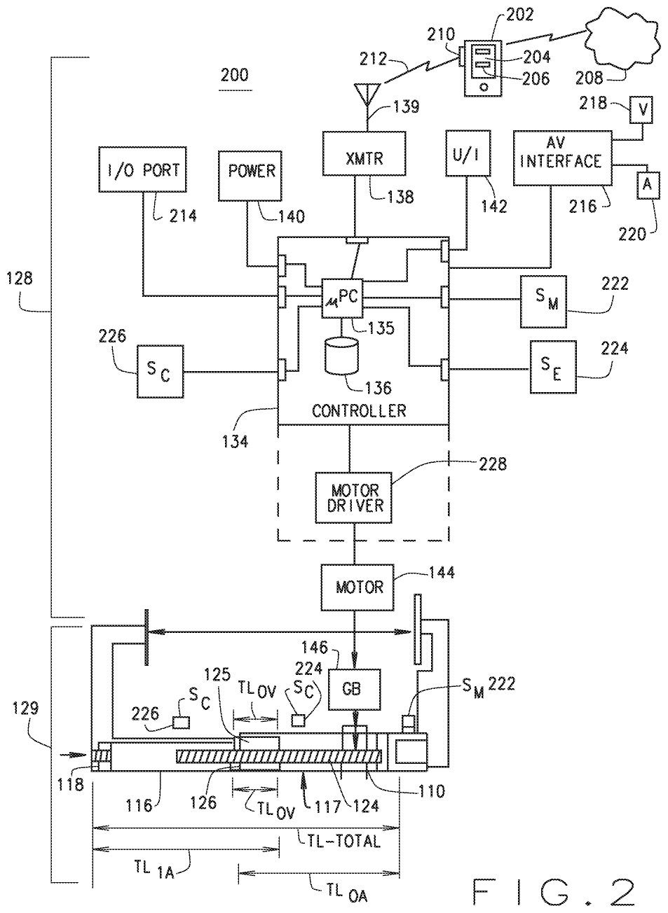

As shown in FIGS. 1A, 1B, 1C, 1D, 1E and 1F (FIGS. 1) is a first exemplary embodiment of a wheel lock assembly according to the present disclosure. A shown in the illustrations of FIGS. 1 the wheel lock assembly 100 is comprised of two primary components the outer assembly 102 and the inner assembly 114. The outer assembly 102 is slidably coupled to the inner assembly 114 through a transverse combined member 117 that is composed of an outer transverse member 110 and a slidably connected inner transverse member 116. The total length TL_{TOT} of the combined transverse member 117 is the sum of the TL_{N} of member 116 plus the total length TL_{O} of the outer transverse member 110 minus the length of the overlap TL overlap or TL_{OV}. Which can also be the length TL_{IN} of the inner transverse member 114 minus that amount of the slidably overlap length total length overlap TL_{OV} which is the overlap portion 125. The varying of the total length TL_{TOT} expands and contracts the distance between outer assembly 102 and the inner assembly 114 for securing about a tire 109 (as shown in FIG. 1D) placed therebetween. As the inner transverse member 116 is compressed towards the outer transverse member 110 when the assembly 100 is used to engage a tire, the amount of the overlap TL_{OV} increases and the total length TL_{TOT} decreases to engage or collapse about the tire. While the two transverse members 110, 116 are shown in this exemplary embodiment to have a rectangular shape, such members can also have a circular, tube or oval shape in other embodiments.

The outer assembly 102 also includes an outer assembly main housing 104, an outer wheel clamping bar 105, an outer vertical wheel clamping member 106 that extends upward from the outer transverse member 110, and an outer vertical support member 107. Each of these may have a different shape than as shown in other embodiments. A wheel lug nut cover 108 can also be provided for covering one or more of the lug nuts of the wheel 109 when attached thereto. While the wheel lug nut cover 108 is shown to have a circular design, and in one embodiment has such a shape or design, other designs are also possible. Generally the structure of the wheel lug nut cover 108 can cover all of the lug nuts, but can only cover a single lug nut, or a subset of the total set of lug nuts that are typically either 4 or 5 for a care or small truck but can be substantially more for a commercial vehicle. The design of the wheel lug nut cover 108 can vary depending on the intended vehicle use. For additional structural support of the lug nut cover 108 from the outer vertical support member, an outer cover gusset 111 can be provided.

The outer main housing 104 can include one or two separate compartments, which in FIGS. 1 are shown as two, but one or more are also possible. While shown as a rectangular frame, the outer main housing 104 can have any shape, including an oval or circle in other embodiments. These compartments contain various electronic and operational components of the assembly 100. This can include an electronics enclosure 130 that is sealed by a electronics enclosure cover 132 having a lock 133. This can include a controller 134, a memory 136, such as may be on a circuit board or the like (not shown), a wireless transceiver 138 with an antenna 139, and can include a power supply 140 such as a battery. The wireless transceiver 138 can be implemented by the various wireless technologies as addressed above. As a transceiver, this can include establishing a wireless transmission with the mobile device 202 (FIG. 2), transmitting required or administrative data to the wireless device 202 and then receiving the unlocking code therefrom. Further, either the outer main housing 104 or the cover 132 can include a user interface 142, 143 that can be as described above, and by way of example, can be in one embodiment a single button, or two or more buttons, or as another type of interface for receiving a user input may be suitable, each of which is operable as an input to the controller 134. The user interface 142, 143 can also include a display screen or indicator lights, and can include a speaker or audio transmitter providing the user with visual and/or audio responses, acknowledgements, instructions, feedback or verifications during use. These can include indicators verifying placement on the tire, an amount of pressure of the assembly 100 on the tire or an amount that has been successfully achieved, or prompts during removal of the assembly 100 from the tire. The display can include instructions that can be activate by the user as to operation of the assembly 100 or as to obtaining the required unlocking means such as by providing a url webpage address that the user can use to obtain unlocking means such as through payment of a time or otherwise as may be determined by the operating entity of the assembly 100, such as a parking authority.

The outer main housing 104 can also include, but could be combined with the electronics enclosure 130, a drive assembly enclosure 148 that contains a motor 144 and a gear box 146 such as a bi-directional drive assembly. This enclosure 148 has a cover 147 and a lock 149 for securing the enclosure. Other drive components could also be included within this enclosure. This can include a proximal end of the locking bar 124 that is driven by the motor 144 and the gear box 146 and rotated within the outer transverse member 110 and to which the distal end is rotatably coupled to a proximal end of the inner transverse member 116 via a connecting structure screw lock end plat 150 that may contain a variable length connecting structure end plate 126 that has a threaded feature for slidably moving the inner transverse member 116 relative to the outer transverse member 110 to change the overlap 125 and therefor the combined transverse length TL_{TOT} for expanding and collapsing the wheel lock assembly 100 about a wheel 109.

The inner assembly 114 can be formed as a single component having the inner transverse member 114 fixedly coupled to the inner vertical member 151 having an inner clamping vertical support member 153 that can include the inner vertical clamping member 114, the inner clamping bar 115. In other embodiments, the inner assembly 114 can be formed by the selective coupling of the inner clamping vertical member 151 to an inner foundation member 155, with the inner transverse member 114 being formed by portion of each. In such embodiments the inner clamping vertical member 151 and its components that include the inner clamping member 114 that engages the inner portion of the wheel 109 is selectably attachable and detachable from the inner base member 154 by an attachable inner transverse base member 155 on which the inner clamping vertical support member 153 is fixedly mounted. An inner gusset 156 can provide structural support between the inner transverse base member 155 and the inner clamping vertical support member 153. The Inner vertical member 151 is selectively attachable to the inner base member 154 of the inner transverse member 116 through one or more foundation to base member couplers 170 as well as by manual lock assembly 118 that is located on the distal end of the inner transverse member 114 at manual lock assembly end plate 152 and inner transverse member removable member locking mount 174.

The inner assembly 114 has its inner transverse member 114 slidably coupled to the outer transverse member 110 via the above mentioned slidable features as well as by the connecting structure 150 having a threaded receiver 172 that receives a variable amount of the locking bar 124 during rotation thereof.

FIG. 2 is a schematic block diagram of operational component system 200 of a wheel lock assembly 100 according various exemplary embodiments. As shown top to bottom, a user wireless device 202 can include a user interface 204 with a user display presentation 204. On such, the communications from the transceiver 138 of the assembly can initiate a display prompting the user to enter a user input code 206 that the user inputs. The user can be using the wireless device to pay the fine using a communication over the communication network 208 and in return obtain the code 206 that the user inputs into the wireless device 202. The wireless device 202 transmits this user input code 206 over the wireless interface 210 of the mobile device which is as described above in communication with the wireless transceiver 138 of the assembly 100 over a local wireless network 212, that may be created and dedicated to the wireless transceiver 138 or can be shared.

The antenna 138 of the transceiver 138 receives the user input code 206 and provides the received code to the controller 134. The controller 134 can include a processor 135 and a nonvolatile and nontransitory memory 136. The assembly electronics 128 are illustrated separately from the assembly drive mechanism 129, but such is only for illustrative purposes and is not intended to be limiting. The assembly electronics 128 can also include a data port 214 for interfacing with a computer or wired device such as via a USB port for receiving computer executable instructions and one or more security codes for unlocking the assembly as discussed herein. As noted such communications can also be via the wireless transceiver 138 in some embodiments. Power for the electronics 128 and the drive mechanism is provided by power supply 140 which is typically a local battery. As addressed above and herein, a user interface 142 is also provided. A audio/visual (A/V) interface 216 is coupled to the controller 134 for communicating indicators or alarms or status via visual indicators 218 or an audio transducer 220 such as a speaker or buzzer or the like.

As addressed above, in some embodiments, a motor driver 228 can be included that interfaces between the controller 136 and the motor 144 for controlling the operations of the motor 144. The assembly 100 can also include one or more sensors. These can include a motion/pressure sensor 222 that can detect an external motion or pressure that is applied to the assembly 100 such as if a person attempts to forcibly remove the wheel lock assembly 100 from the wheel 109 or attempts to move the vehicle. This can initiate an audio or visual alarm or can disable the assembly 100 or in some cases can initiate a wireless communication by the assembly 100 to a remote reporting location indicating the attempted tampering with the wheel lock assembly 100. Another expansion sensor 224 (S_{E}) can detect the length or a point of the length of the extended length of the transverse member 117 in order to provide feedback to the controller 134 that the maximum predetermined length TL_{TOT} of the transverse member 117 has been reached during expansion. In this manner, the assembly 100 automatically stops the expansion so that the inner assembly 114 does not become detached from the outer assembly 102 and is ready for positioning on the next wheel 109. Similarly, a compression sensor 226 (S_{C}) can be provided that detects the reduction or compression length or pressure that is being applied by the assembly 100 during operation of the motor 144 in reducing the length TL_{TOT} of the transverse member 117 to secure or lock the assembly 100 onto a wheel 109 that is being locked upon receipt of a lock input instruction from a user, such as from the user interface 142. In this manner, either the reduced length TL_{TOT} can be limited to an amount that is optimally operable for the assembly 100 such as to prevent the locking bar 1224 from extended and contacting the distal end of the inner transverse member 116, such as the end locking plate 125, and/or the pressure being applied by the inner and outer wheel clamping members 106, 114 on the sides of the wheel 109 to which the assembly is being secured is only allowed to reach a maximum clamping pressure such as may be predetermined and stored in the memory 136. In this manner, a consistent securing force is applied by the assembly 100 in all applications that may be desirable that is regardless of the size of the wheel 109 or the ability of the operator to attach the assembly 100 to the wheel 109.

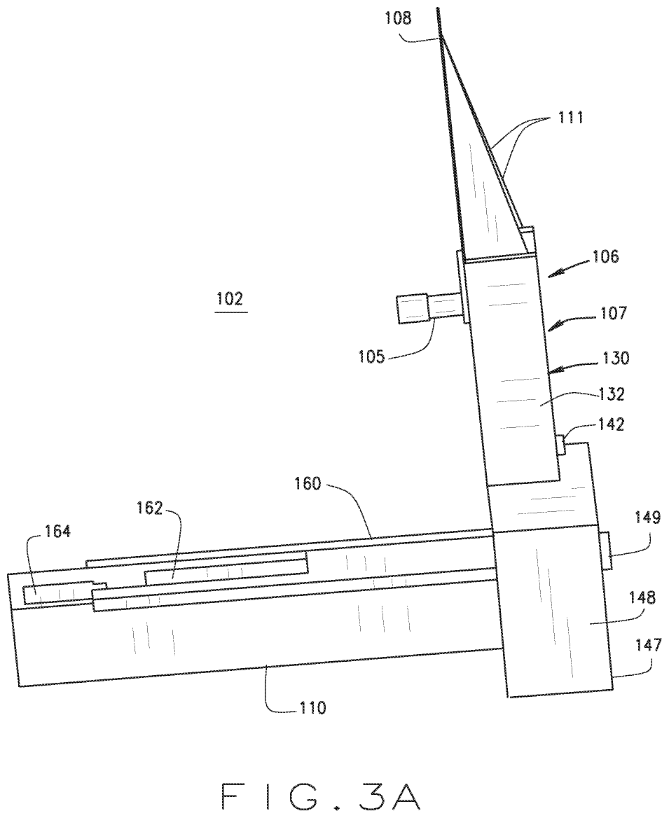

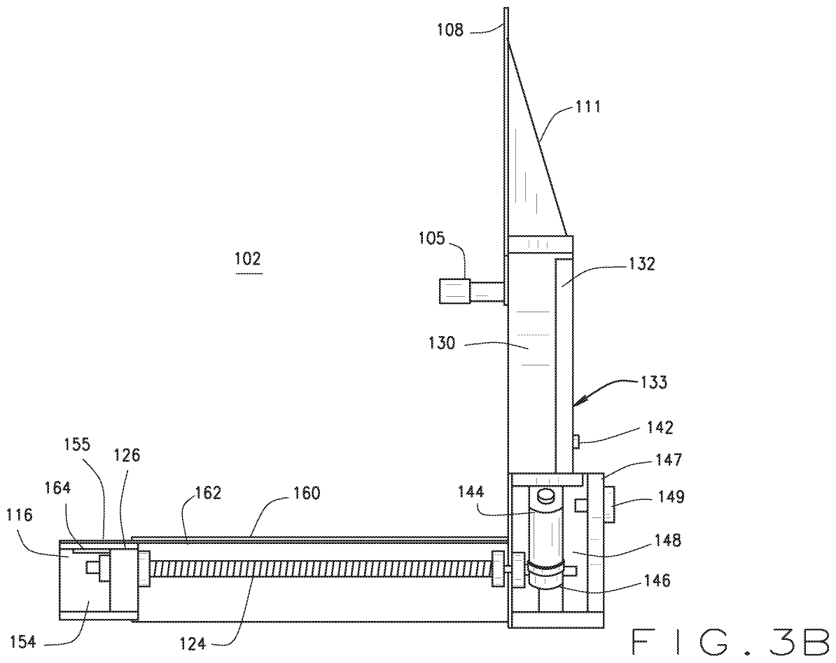

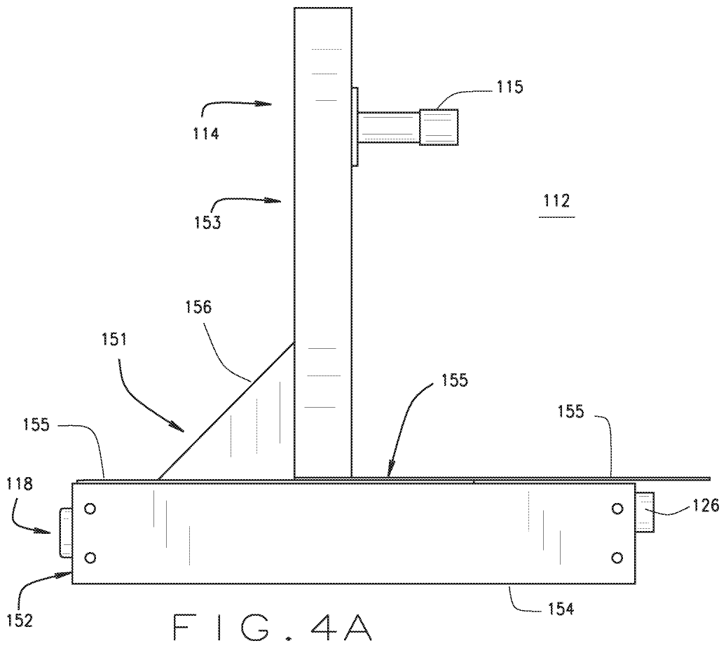

FIGS. 3A and 3B are images of an outer assembly 102 of a wheel lock assembly according to one exemplary embodiment. In addition to the features already described with regard to FIGS. 1. FIG. 3A illustrates a outer transverse member cover plate 160, a outer transverse member slide plate 162 and a outer transverse member slide connector feature 164. The outer transverse member cover plate 160 and the outer transverse member slide plate 162 slide along a base of the outer transverse member 110 as the inner transverse member 116 overlaps therewith during operation thereof. The connecting features 164 as described herein can be a slot or grove for mating with mating features of the inner transverse member 114. As shown in FIG. 3A, the inner transverse member 114 would have a smaller outer dimension than the hollow inner dimension of the outer transverse member 110 so that the inner transverse member 114 slides within the hollow outer transverse member 110 during extension and reduction of the length of the transverse member 117 by operation of the screw locking bar 124 as driven by the motor as shown in FIG. 3B.

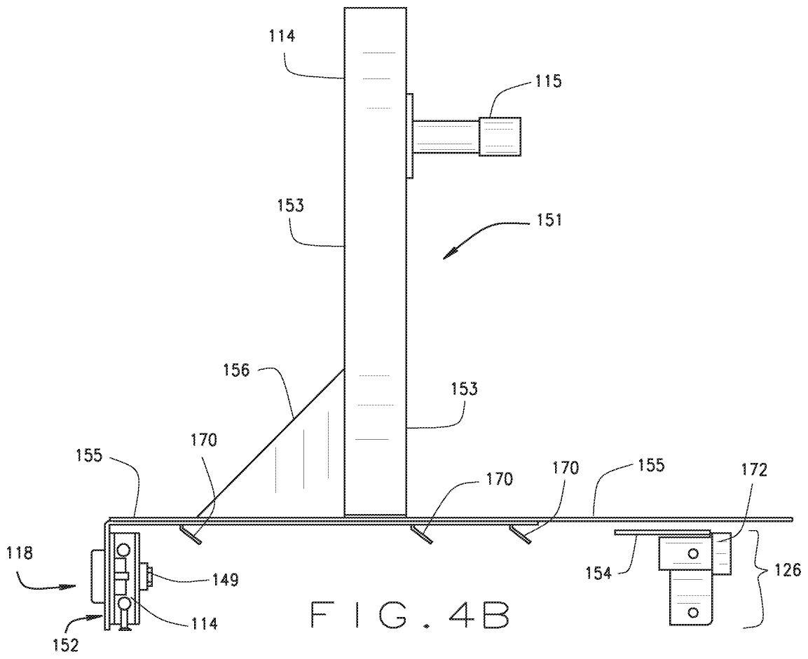

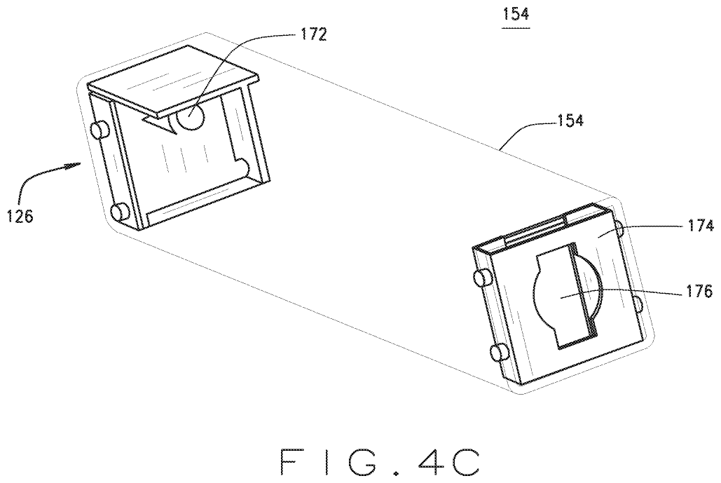

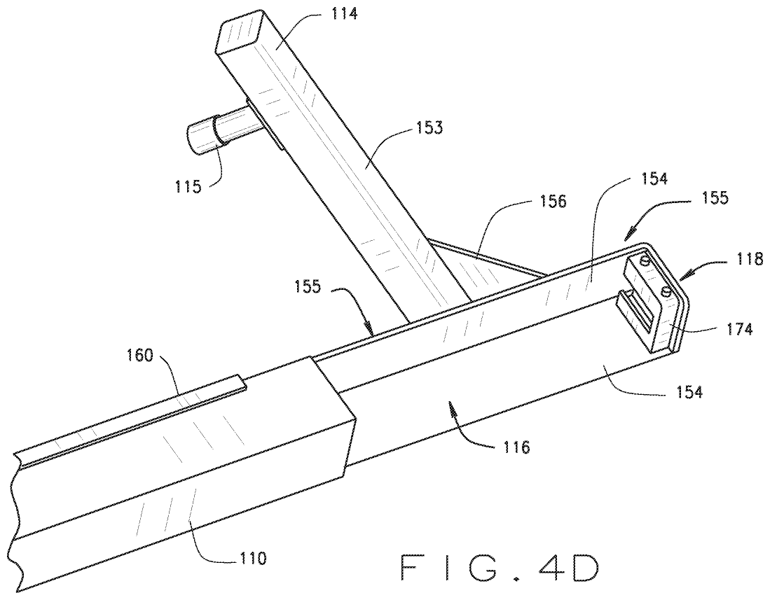

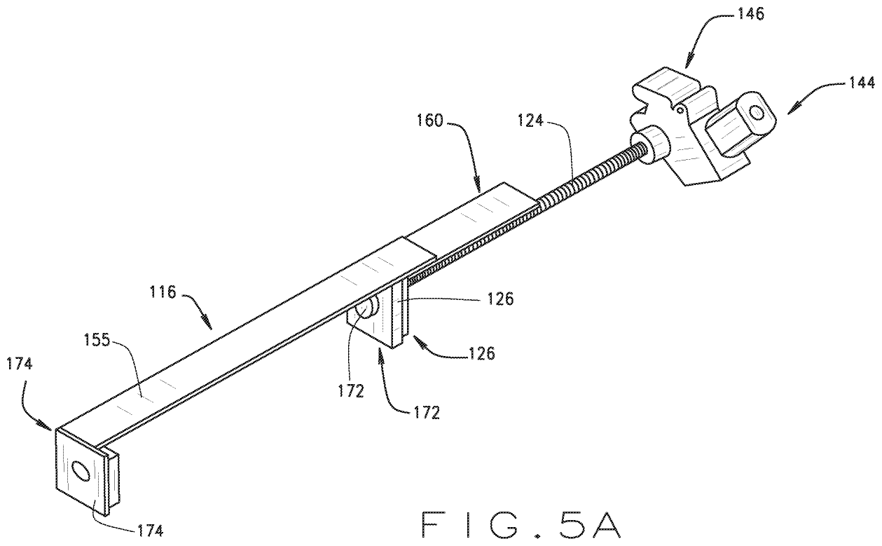

FIGS. 4A, 4B, 4C and 4D are images of an inner assembly of a wheel lock assembly according to one exemplary embodiment. These are a previously described with regard to FIGS. 1 but with greater detail. This includes the foundation to base member couplers 170 that are shown an interlocking tabs or fingers that fit into slots of the top of the inner transverse base member 154. Also as shown, the inner transverse removable member locking mount 174 includes a manual lock receiver 176 for the lock 118.

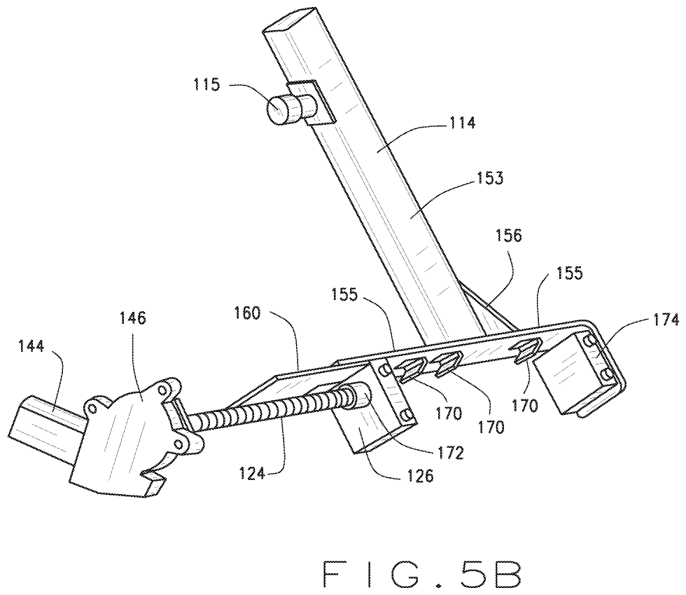

FIGS. 5A and 5B are illustrations of a motor drive assembly for a wheel lock assembly according to one exemplary embodiment. These figures illustrate that the motor 144 rotates the locking bar 124 via the gear box 146 (GB) at a proximal end of the locking bar 124. The distal end of the locking bar 124 engages the variable length connecting structure end plate 126 of the inner transverse member 116 that has the threaded receiver 172 each at the proximal end of the inner transverse member 116. At the distal end is the manual lock 118 with the removable member locking mount 174 that mounts and secures the vertical foundation member 155 to the inner base member 154.

### Methods of Operation

Further, embodiments of the present disclosure include various embodiments of methods of operation for locking and unlocking a wheel of a vehicle using a wheel locking assembly or boot that is an improvement over the prior systems and methods.

According to one embodiment of operation, a method of operating an automotive vehicle wheel locking assembly includes the steps of receiving at a first data interface of the assembly at least one unlock code, and storing the received at least one unlock code in a memory of the assembly. The method then includes receiving at a user interface of the boot a lock input and generating by a controller an assembly lock motor command to a motor of the assembly responsive to receiving of the lock input. The method then includes operating the motor in a first direction and responsive thereto, rotating a locking bar in a first direction, the operating being responsive to the generating of the lock motor command and responsive to the locking bar rotating in the first direction, slidably moving an inner transverse member in the direction towards an outer transverse member contracting or reducing a combined transverse member length defined by the lengths of the inner and outer transverse members and reducing a wheel locking distance defined between an outer wheel clamping member associated with the outer transverse member and an inner wheel clamping member associated with the inner transverse member and placing the assembly in a wheel locked state.

The method then includes that following the placement of the assembly in the wheel locking state, receiving over a second data interface an unlock code input from a user and comparing the received unlock input with the memory stored at least one unlock code. The method also includes generating an unlock motor expansion command to the motor responsive to a successful comparing, operating the motor in a first direction responsive to the generated unlock motor expansion command, and rotating the locking bar in a second direction. The method further includes that in response to the locking bar rotating in the second direction, slidably moving the inner transverse member in the direction away from the outer transverse member expanding the combined transverse member length and expanding the wheel locking distance and placing the assembly in a wheel unlocked state.

In some embodiments, the receiving and storing of at least one unlock code is the receiving and storing of a single unlock code per assembly. In other embodiments, the stored unlock code can be multiple security codes such as a master code and a user changeable code.

In some embodiments, the method includes, following the placing of the assembly in a wheel lock state, the step of receiving a manual unlock input from a user of a manual locking mechanism positioned on the inner transverse member, removing a removable inner clamp foundation member having the manual locking mechanism and the inner clamping member fixedly mounted thereon from a base member of the inner transverse member that is in slidable transverse engagement with the outer transverse member that forms the combined transverse member and combined transverse member length and removing the outer transverse member from the wheel.

This can include, following the removing of the removable inner clamp foundation member from the base member of the inner transverse member and the removal of the outer transverse member from the wheel, the steps of attaching the removable inner clamp foundation member to the base member, receiving a manual lock input from a user of the manual locking mechanism, and securing the removable inner clamp foundation member to the base member by the manual locking mechanism.

In some embodiments, the first data interface is a wired data interface and the receiving is receiving the at least one unlock code is using a wired communication protocol.

In some embodiments, the wired data interface of the first data interface and the wired communication protocol are within the universal serial bus (USB) family of wired data interfaces and protocols.

In some embodiments, the first data interface is a wireless data interface and in some embodiments, the receiving is receiving of the at least one unlock code is using a wireless communication protocol.

In some embodiments, the receiving is via a wireless data interface using a wireless communication protocol or method of wireless communications compatible with Wi Fi, Bluetooth, near field communications (NFC), infrared, satellite, and mobile telephone telecommunications.

In some embodiments, the user interface at which the lock input is received is a user operated button or switch or keyed feature communicatively coupled to the controller.

In some embodiments, the second data interface is a wireless transceiver interface and the receiving of the unlock code input from the user includes the receiving of the unlock code input is via a wireless communication protocol.

In some embodiments, the second data interface is selected from the group of wireless communications technologies consisting of Bluetooth, near field communications (NFC), infrared, satellite, and mobile telephone telecommunications.

In some embodiments, the second data interface is a Wi-Fi transceiver interface receiving the unlock code input is via an Wi-Fi encrypted messages.

In some embodiments, the transceiver interface is configured by computer executable code and its interconnections to the various component systems described herein for communications with only locally positioned mobile devices using the Wi-Fi communication access point security certification protocol.

In some embodiments, the method includes receiving over a manual wake-up input interface of the assembly a manual wake-up input from a user, providing a wake-up instruction to the controller for activating the controller and the second data interface, transmitting from the second data interface a Wi-Fi access point security certification message prompting for entry of a Wi-Fi security key. This can include in sonic embodiments, the wireless transceiver performing the process of receiving a user Wi-Fi security key response to the Wi-Fi access point security certification message, and responsive to the transmitting, receiving a Wi-Fi security key as the unlock code input.

In some embodiments, the method includes, that upon the placing of the assembly in the wheel lock state and placing the assembly in the wheel unlock state, the step of placing the processor and the second data interface into a low power sleep mode.

In some embodiments, the method includes receiving a user input from user operating a wake-up input interface and generating a wake-up instruction to the controller for activating the controller and the second data interface and removing the controller and the second data interface from the low power sleep mode, and transmitting from the second data interface a transmission message including a request for a user input unlock code.

In some embodiments, the second data interface is a Bluetooth or a Near Field Communication (FNC). In some embodiments, this includes transmitting over the second data interface using encrypted messaging for receiving the user code input.

In some embodiments, the method includes the steps of receiving over a manual wake-up input interface of the assembly a manual wake-up input from a user, providing a wake-up instruction to the controller for activating the controller and the second data interface, transmitting from the second data interface a security key request message prompting for entry of a security key, and responsive to the transmitting, receiving a security key as the unlock code input.

In some embodiments, the motor is a bidirectional motor and the locking bar is a screw threaded bar having a first end rotatable muffled at a fixed position relative to the outer transverse member and a second end extending from the outer transverse member in the direction of the inner traverse member, and rotating the locking bar including rotatably engaging a threaded cam or nut assembly associated with a portion of the inner transverse member providing the slidable movement of the inner transverse member relative to the outer transverse member for reducing and expanding the combined transverse member length.

In some embodiments, the method includes prior to the receiving the lock input at the user interface, the step of placing the assembly about an automotive vehicle wheel with the outer wheel clamping member being placed to cover one or more lug nuts of the wheel and the inner wheel clamping member being placed within an inner cavity defined by the inner side of the wheel. In some embodiments, the reducing of the wheel locking distance places the outer clamping member and the inner clamping member in a clamping pressure securing the assembly to the automotive vehicle wheel and inhibiting access to the covered one or more lug nuts of the wheel.

In some embodiments, the method includes detecting a motion of the assembly when in the wheel lock state, and generating at least one of an audio and a visual alarm over a audio/visual generator assembly responsive to the detecting of the motion.

In some embodiments, the method includes detecting an external pressure being applied to the assembly including between the outer clamping member and the inner clamping member when in the wheel lock state, and generating at least one of an audio and a visual alarm over an audio/visual generator assembly responsive to the detecting of the motion.

In some embodiments, the method includes during operating the motor in the first direction and rotating the locking bar in the first direction, detecting an amount of pressure being applied between the outer wheel clamping member and the inner wheel clamping member, comparing the detected amount of pressure to a predetermined clamping pressure as stored in the memory, and terminating the operating of the motor in the first direction when the detected amount of pressure is equal to or greater than the stored predetermined clamping pressure.

In some embodiments, the method includes during operating the motor in the second direction and rotating the locking bar in the second direction, detecting a detected expansion length that is either the combined transverse member length or the distance of the movement of the inner transverse member away from the outer transverse member, comparing the detected expansion length to a predetermined expansion length as stored in the memory, and terminating the operating of the motor in the second direction when the detected expansion length is equal to or greater than the stored predetermined expansion length.

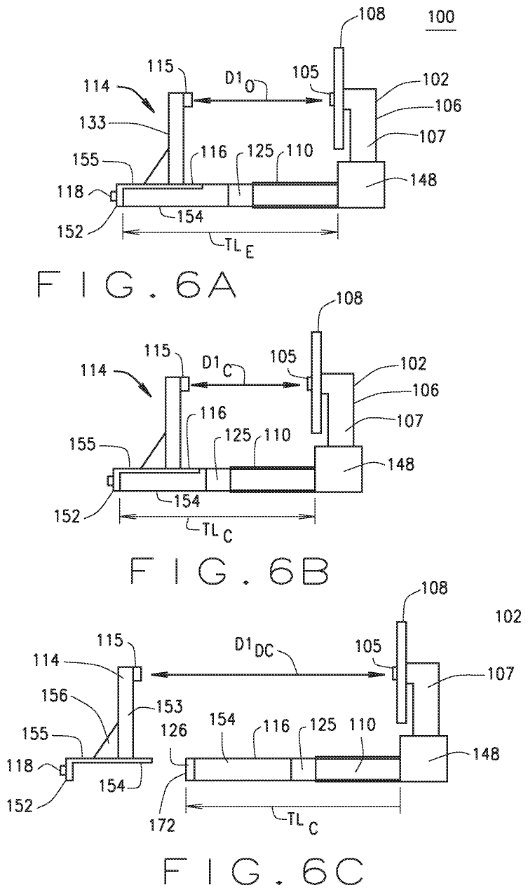

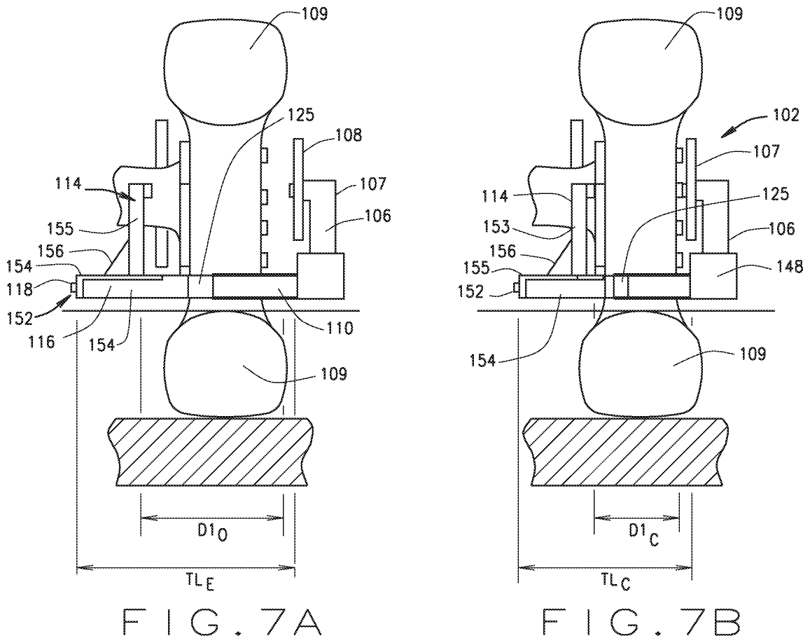

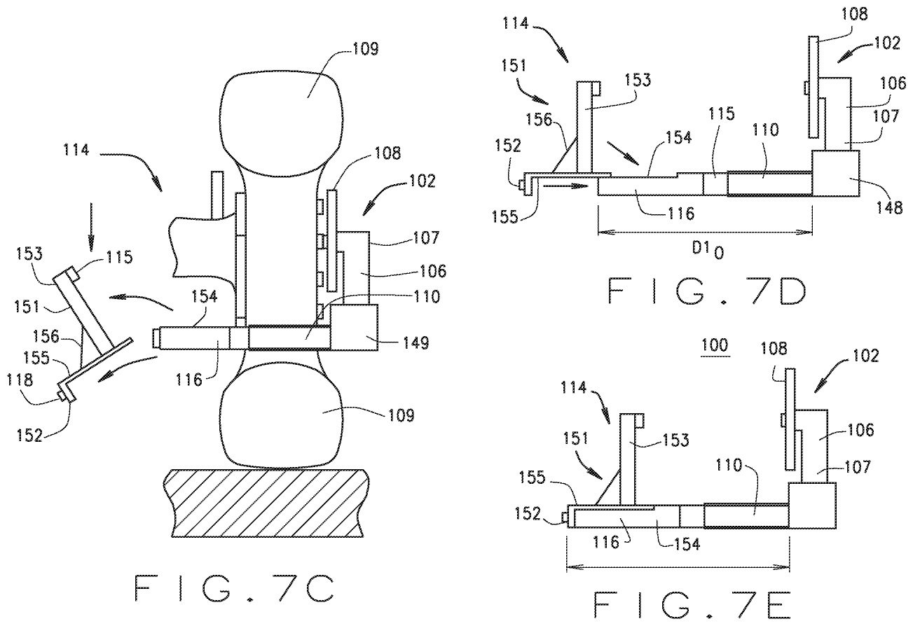

FIG. 6A, 63, and 6C are illustrations of one method of operating one embodiment of a wheel lock assembly. As shown in FIG. 6A, the outer assembly clamping member 106 is set apart from the inner assembly clamping member 114 at a distance D1₀ when the transverse length TL is extended total length TL_{E}. FIG. 6B illustrates that when the lock input is received, the motor 144 operates to collapse or reduce the transverse length TL to a lesser amount of collapsed total length TL_{C} and in so doing the distance between the outer assembly clamping member 106 and the inner assembly clamping member 114 reduces to distance D1_{C} which is secured about the wheel 109 (not shown). If a valid unlock code is received by the assembly 100, the motor 144 reverses its direction and expands the transverse length TL back to TL₁₀ and the assembly 100 can be removed from the wheel 109, which is shown in Fig, 6C with the inner assembly clamping member 114 being separated from the outer assembly clamping member 110 by the expanded distance D1_{DC} (D1 Disconnected). In some embodiments, the removable inner vertical member 151 including the inner assembly clamping member 114 can be manually disconnected and detached from the inner transverse base member 154 by insertion of a manual key (not shown) into the manual lock 118 and the foundation member 155 with the vertical clamping member 114 detached from the base member 154 thereby separating the inner transverse member 114 into two portions. In such a manner, the inner clamping member 114 is physically removed from the inside of the wheel 109 and the assembly 100 can be removed from the wheel 109 without operation of the motor 144 or the changing of the total transverse length TL_{OUT} from the locked reduced transverse length TL_{C}. This same operation is shown in another set of views in FIGS. 7A, 7B, 7C, and 7E. FIG. 7D illustrates the replacement and reattachment of the removable inner vertical member by attached the foundation member 155 back onto the base member 154 and locking of the lock 118 to the lock receiver 152 of the base member 154. In this manner, after manual removal of the assembly 100, the assembly 100 is reassembled for future use.

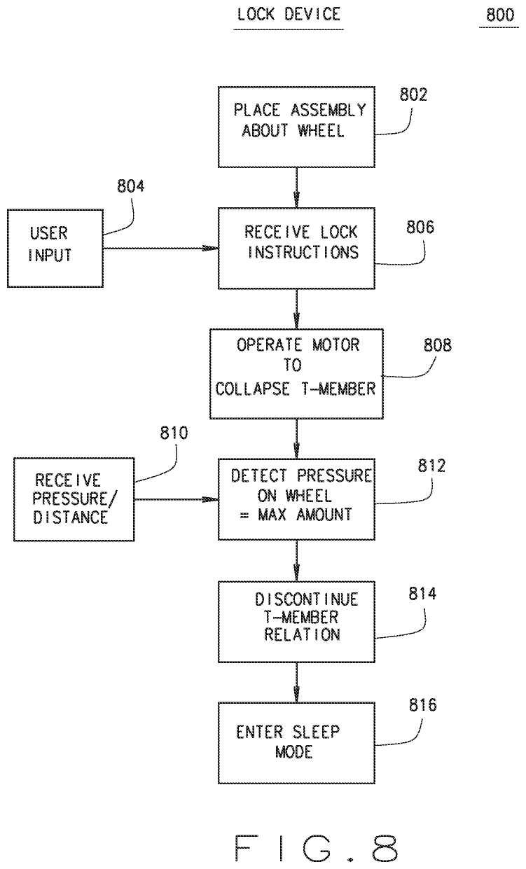

FIG. 8 is a flow chart illustrating a process flow of engaging a wheel lock assembly onto a wheel according to one exemplary embodiment. This is a simplified process 800 for placing the assembly 100 onto a wheel 109. In process 802 the assembly 100 is placed about the wheel 109. A user input is made in process 804 such as by the user interface 142 or 143 and is received instructing the controller 134 to lock the assembly 100 about the wheel in process 806. The controller 134 sends a reduction or collapse command or control to the motor to collapse or reduce the transverse length TL in process 808. In this example, the pressure sensor 222 (S_{M}) detects a pressure being applied by the assembly 100 on the wheel 109 in process 810 and forwards the detected pressure to the controller 134 wherein it is compared by the controller 134 to a maximum or predetermined pressure that is stored in memory 136 as shown in process 812. Once the pressure is reached, the controller 134 discontinues or stops the further operation of the motor 144 that stops the reduction of the length TL in process 814 and the assembly 100 is secured to the wheel 109. The assembly 100 than enters the low power sleep mode in process 816.

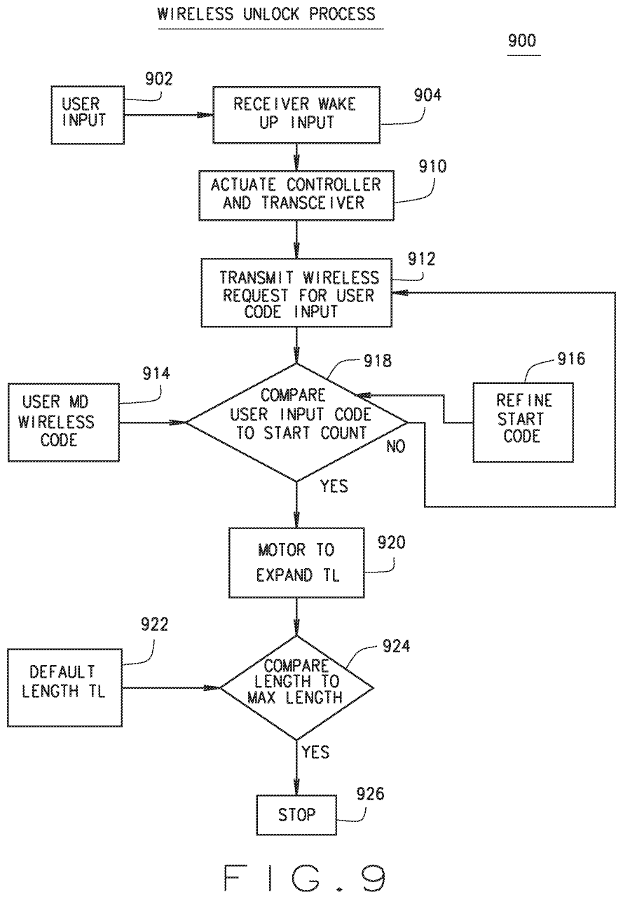

FIG. 9 is a flow chart illustrating a process flow of wireless unlocking of the wheel lock assembly from a wheel according to one exemplary embodiment. It is assumed that the assembly 100 is locked about a wheel 109. A user wanting to unlock the assembly 100 from the wheel 109 obtains a user code from an authorizing entity and instructs the assembly 100 to wake up in process 902 such as by pushing a wake up button on the assembly 100 that is the user interface. The assembly 100 receives the wake up input in process 904 and activates the controller 134 and the wireless transceiver 138 in process 910. Upon waking up, the wireless transceiver 138 initiates a wireless transmission prompting a receiving wireless unit to input a user code for unlocking the assembly 100 in process 912. The user inputs the user code in 914 that is transmitted wirelessly to the transceiver 138 of the assembly 100 and received thereby. The controller 134 retrieves the stored security code from the memory 136 in process 916 and compares the received user input code with the stored security code in process 918. If the codes do not match, the process returns to process 912 wherein the transceiver sends another prompt wirelessly to the user wireless device 202 for retry. If the received code matches in process 918, the controller 134 directs the motor 144 to operate to expand the transverse length TL in process 920. In some embodiments, the maximum length or expansion sensor 224 detects when the maximum desired length of the TL is obtained in process 922 and forwards that to the controller where in process 924 the controller compares that to the desired or predetermined maximum TL length and when reached stops the motor in process 926.

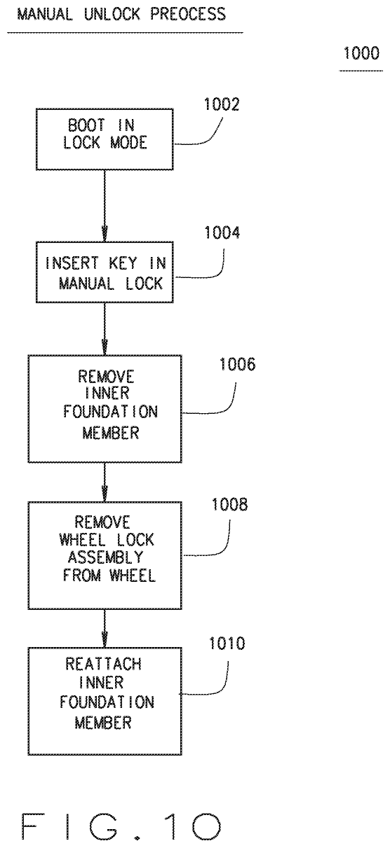

FIG. 10 is a flow chart illustrating a process flow for disengaging a wheel lock assembly from a prior locked wheel according to one exemplary embodiment. The process 1000 assumes that the assembly is locked in process 1002 about a wheel 109 and for some reason the wireless interface is not working or the user has a manual key and does not enter the wireless code. In this case in process 1004 the user inserts a key and in process 1006 the user removes the inner foundation member 151 from the inner base member 154 and then removes the assembly 100 from the wheel in process 1008. Afterwards, the user reattaches the inner foundation member 151 to the inner base member 154 to reassembly the assembly 100 for its next use.

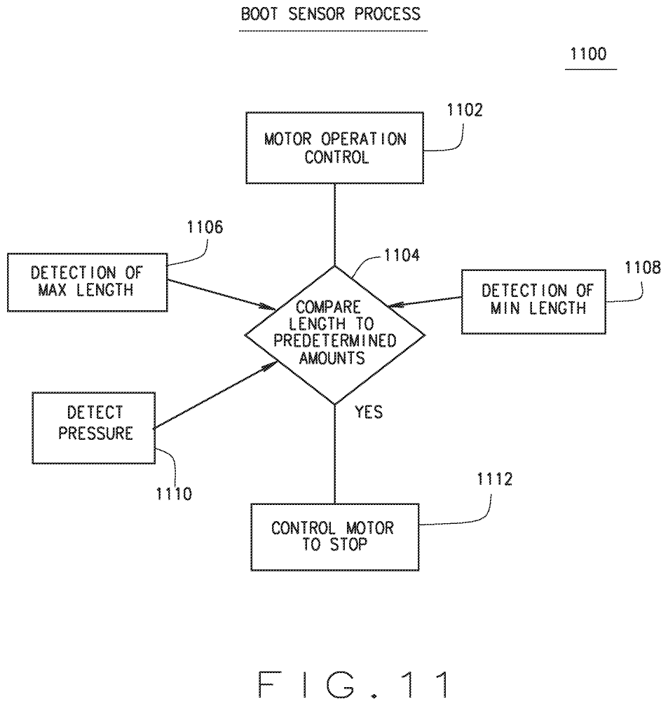

FIG. 11 is a flow chart illustrating various wheel lock sensing and controlling features according to various embodiments of the wheel lock assembly. Process 1100 illustrates the controller 134 control of the motor 144 based on inputs from sensors 222, 224, 226 as described above. In process 1102, the controller 134 operates the motor 144 and sensor 222 detects that pressure applied by the assembly 100 during the collapsing or transverse length reduction in process 1110 and the controller compares this to the stored or predetermined maximum or desired pressure on the wheel in process 1104. Once the pressure is reached, the controller 134 instructs the motor 144 to stop its reduction in process 1112. In another operation, maximum length sensor 224 provide an extended length to the controller in process 1106 wherein in process 1104 the controller determines if the length has reached the maximum predetermined length and when reached as determined in process 1104, the controller 134 instructs the motor to stop operation in process 1112. When in operation, the minimum length sensor 226 detects the minimum reduction length in process 1108 the controller compares that to the minimum allowable length in process 1104 and when reached instructs the motor to stop operation in process 1112. Of course other sensors and operation are also possible and within the scope of this disclosure.

### Locking Wheel Assembly Controller and Communication System Environments

While specific exemplary examples, environments and embodiments are discussed herein, one of skill in the art should be understood that this is done for illustration purposes only. A person skilled in this art will recognize that other components and configurations can be used without parting from the spirit and scope of this disclosure. In fact, after reading the following description, it will become apparent to a person skilled in the relevant art how to implement numerous disclosed and supported embodiments as in alternative examples, environments and embodiments.

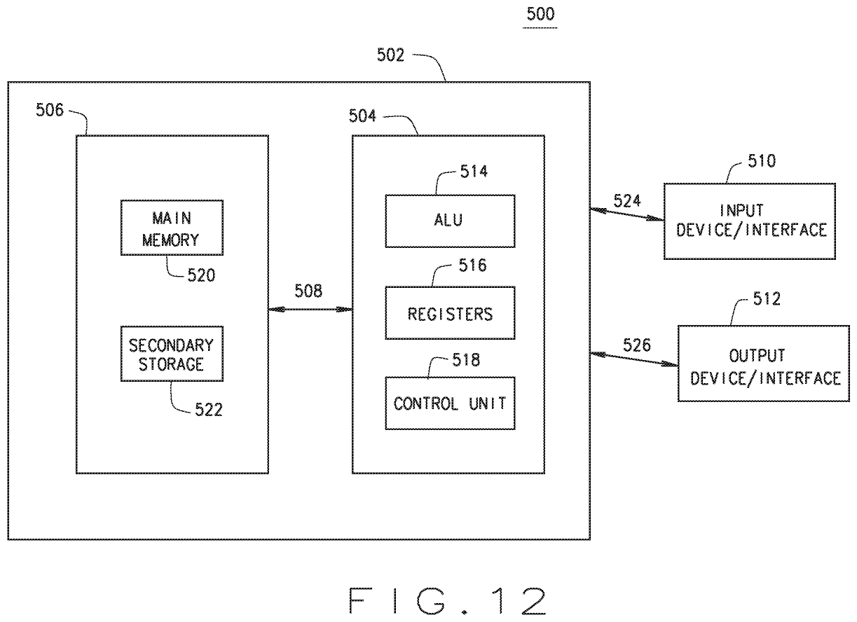

Referring now to FIG. 12, an operating environment for one or more illustrated embodiments of various components or modules as described above can include a computer or processing system 500 having a computer 502 that comprises at least one high speed processing unit (CPU) 504, in conjunction with a memory system 506 interconnected with at least one bus structure 508, an input device 510, and an output device 512. These elements are interconnected by at least one bus structure 512. Examples of power control systems having one or more of these exemplary operating environment components, can include the power controllers, the local and remote user interfaces, the gateway, the operations system, and the remote operational system, by way of example.

The illustrated CPU 504 is of familiar design and includes an arithmetic logic unit (ALU) 514 for performing computations, a collection of registers 514 for temporary storage of data and instructions, and a control unit 516 for controlling operation of the system 500. Any of a variety of processor, including at least those from Digital Equipment, Sun, MIPS, Motorola/Freescale, NEC, Intel, Cyrix, AMD, HP, and Nexgen, is equally preferred for the CPU 504. The illustrated embodiment of the disclosure operates on an operating system designed to be portable to any of these processing platforms.

The memory system 506 generally includes high-speed main memory 520 in the form of a medium such as random access memory (RAM) and read only memory (ROM) semiconductor devices, and secondary storage 522 in the form of long term storage mediums such as floppy disks, hard disks, tape, CD-ROM, flash memory, etc., as well as other devices that store data using electrical, magnetic, optical or other recording media. This can include non-transitory and nonvolatile memory that is separate from the processor 504 or can be incorporated therein. Those skilled in the art will recognize that the memory system 506 can comprise a variety of alternative components having a variety of storage capacities.

The input device 510 and output device 512 are also familiar and can be implemented associated with the local and remote user interfaces as well as a controller, remote operational system and operations system, by way of example. The input device 510 can comprise a button or switch in some embodiments. However in other embodiments a keypad, a physical transducer (e.g., such as a motion detector or microphone), or data interface can be interconnected to the computer 502 via an input interface 524. The output device 512 can comprise an audio transducer (e.g. a speaker), etc., or one or more lights or LEDs or can include a presentation on a display in come embodiments.

As described herein, a remote wireless device that communicates with the wheel locking assembly via the data interface or the wireless transceiver interface can be any suitable device, including, but not limited to, handheld wireless devices and wireline devices (such as personal digital assistants (PDAs), cell phones with processing capability, wireless e-mail devices including i-Phone™, Android™, BlackBerry™, Palm™ or Gamet™, Samsung™ Bada™, Windows™ Phone™, Window™ Mobile™, Nook™ and i-PAD™ and similar devices and operating systems).

As is familiar to those skilled in the art, the computer system 500 further includes an operating system and at least one application program. The operating system is the set of software which controls the computer system's operation and the allocation of resources. Those of skill in the art will recognize that suitable operating systems can include, by way of non-limiting examples, Apple OS®, Microsoft® Windows®, Microsoft®, Windows®, Apple® Mac OS X®, UNIX®, and UNIX-like operating systems such as GNU/Linux®. The application program is the set of software that performs a task desired by the user, using computer resources made available through the operating system. Both are resident in the illustrated memory system 506. As known to those skilled in the art, some of the methods, processes, and/or functions described herein can be implemented as software and stored on various types of computer readable medium as computer executable instructions. In various embodiments of the power control system described by example herein, the controller can include a robust operating and application program having the computer executable instructions for controlling the controller and the controlled devices. Additionally, one or more of the local and remote user interfaces, operations system and remote operations system can include, among other application software programs with computer executable instructions, a thin client application for communicating and interactively operating with one or more controllers as described above by way of example.

In accordance with the practices of persons skilled in the art of computer programming, the present disclosure is described below with reference to symbolic representations of operations that are performed by the computer system 500. Such operations are sometimes referred to as being computer-executed. It will be appreciated that the operations which are symbolically represented include the manipulation by the CPU 504 of electrical signals representing data bits and the maintenance of data bits at memory locations in the memory system 506, as well as other processing of signals. The memory locations where data bits are maintained are physical locations that have particular electrical, magnetic, or optical properties corresponding to the data bits. The disclosure can be implemented in a program or programs, comprising a series of instructions stored on a computer-readable medium. The computer-readable medium can be any of the devices, or a combination of the devices, described above in connection with the memory system 506.

It should be understood to those skilled in the are, that some embodiments of systems or components described herein may have more or fewer computer processing system components and still be within the scope of the present disclosure.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

1. An assembly for selectively locking a wheel of an automotive vehicle having an outer assembly for engaging the outer portion of the wheel and an inner assembly for engaging the inner portion of the wheel and an inner assembly for engaging the inner portion of the wheel, the assembly comprising:
the outer assembly selectively coupled to the inner assembly, the outer assembly having an outer transverse member protruding inward and having an outer transverse member length that is slidably coupled to an inner transverse member protruding outward and having an inner transverse member length and forming a transverse member overlap having an overlap length, the coupling including a slidable engaging fixtures and a locking bar rotatably coupled to the outer assembly and to the inner assembly;
a local power supply;
a motor powered by the local power supply; and
a bi-directional gear drive mechanism engaged with the motor and with the rotatable locking bar and configured to rotate the locking bar responsive to the rotation of the motor in a clockwise direction and a counterclockwise direction;
wherein the locking bar is rotatably coupled to the outer assembly in a fixed position and rotatably coupled to a locking bar receiver of the inner assembly for varying the transverse member overlap and the overlap length and a total transverse member length formed by the slidably coupling of the inner transverse member and outer transverse member responsive to the rotation of the locking bar by the motor and the gear drive mechanism.

2. The assembly of claim 1, the outer assembly has an outer wheel clamping member and the inner assembly has an inner wheel clamping member that is selectively attachable to the inner transverse member, further comprising a manual locking assembly selectively fixedly securing the inner wheel clamping member to the inner transverse member.

3-73. (canceled)

74. The assembly of claim 2 wherein the manual locking mechanism is positioned at an outer end of the inner transverse member that is opposing an inner end that slidably engages with the outer transverse member.

75. The assembly of claim 1, further comprising:
a controller with a processor and a non-transitory non-volatile memory storing computer executable instructions and at lease one unlock code;
a wireless transceiver operatively coupled to the controller, the wireless transceiver configured for receiving a user code from a remote wireless device, the controller configured for comparing the received user code with stored unlock code and generating an unlock command responsive to a successful comparing, the motor, bi-directional gear drive mechanism and the locking bar being responsive to the unlock command and rotating the locking bar to expand the total transverse length to expand a distance between the outer wheel clamping member and the inner wheel clamping member enabling the removal of the assembly from the wheel.

76. The assembly of claim 75 wherein the controller is configured to receive a user lock input to generate an assembly lock command to the motor, the motor being responsive to the lock command rotating the bi-directional gear drive mechanism and the locking bar to reduction the total transverse length to reduce the distance between the outer wheel clamping member and the inner wheel clamping member.

77. The assembly of claim 75 wherein the assembly includes a data interface including a data port coupled to the controller for communicating instructions with the controller from an external assembly control system coupled thereto.

78. The assembly of claim 75 wherein the memory storing a single unlock code, and wherein the assembly includes a data interface port coupled to the controller and wherein the single unlock code is received by the controller through the data interface port and stored in at the nonvolatile memory until over written by receipt of a replacement unlock code as received by the controller over the data interface port.

79. The assembly of claim 75, further including a transverse length sensor positioned to detect the total transverse length and coupled to the controller to provide a detection of the transverse length to the controller, the controller configured to control the motor for controlling the expansion and the reduction of the total transverse length responsive to the detection.

80. The assembly of claim 75, further including a transverse expansion limit detector positioned to detect the expanded transverse length of the combined inner and outer transverse members and provide a detection of the expanded transverse length to the controller, the controller configured to terminate the generation of the transverse length expansion command responsive to the detection.

81. The assembly of claim 75, further including a transverse reduction pressure sensor to detect an amount of pressure applied during the reduction process and provide the detected pressure to the controller, the controller configured to compare the detected pressure with a predetermined maximum pressure and to terminate the generation of the transverse length reduction command to the motor responsive to the detection.

82. The assembly of claim 75, further comprising a motion sensor positioned on the assembly configured to detect an amount of motion of the assembly when the assembly is in a locked mode, the motion sensor coupled to the controller, and an audio generator operatively coupled to the controller, wherein the controller is configured to receive the detected amount of the motion from the motion sensor, compare the received detected amount of motion to an alarm threshold motion threshold as stored in the memory, and to generate an audible alarm over the audio generator responsive thereto.

83. The assembly of claim 75, further comprising a pressure sensor positioned on the assembly configured to detect an amount of pressure applied by an external force to the assembly when the assembly is in a locked mode, the pressure sensor being coupled to the controller, and an audio generator coupled to the controller, wherein the controller is configured to receive the detected amount of the pressure from the motion sensor, compare the received detected amount of pressure to an alarm threshold pressure threshold as stored in the memory, and to generate an audible alarm over the audio generator responsive thereto.

84. The assembly of claim 75, further comprising a user interface coupled to the controller for receiving a lock input from a user wherein user interface for receiving the lock input is a button.

85. The assembly of claim 75 wherein the controller includes a clock or timer feature configured to place the controller and wireless transceiver in a sleep mode following that locking of the assembly about the automotive tire and following the unlocking of the assembly from the automotive tire.

86. The assembly of claim 85 wherein the outer assembly includes a user interface coupled to the controller to receive a manual wake-up input from a user and provides a wake-up instruction to the controller for activating the controller and the transceiver, wherein the transceiver is responsive thereto and wirelessly transmit a secure pairing protocol prompting for input of a security key, wherein the wireless transceiver is configured to receive user security key responsive to the secure pairing protocol prompt and provide the received user security key as the user code to the controller responsive.

87. The assembly of claim 1 wherein the locking bar is a screw threaded bar and the locking bar receiver is a female threaded nut member fixedly mounted to a proximal end of the inner transverse member.

88. The assembly of claim 87 wherein the motor is a bidirectional motor driver coupling the motor to the screw threaded bar for rotating the threaded bar in two directions for reducing and expanding the transverse length.

89. The assembly of claim 1, further comprising a wheel hub nut cover configured and dimensioned to covering a center of the outer portion of the wheel including all of the wheel lug nuts.

90. An assembly for selectively locking a wheel of an automotive vehicle having an outer assembly for engaging the outer portion of the wheel and an inner assembly for engaging the inner portion of the wheel and an inner assembly for engaging the inner portion of the wheel, the assembly comprising:
the inner assembly having an inner wheel clamping member and an inner transverse member; and
the outer assembly having an outer assembly main housing, an outer wheel clamping member and an outer transverse member slidably coupled to the inner transverse member, a power supply, a controller with a processor and a non-transitory non-volatile memory, computer executable instructions and at lease one unlock code stored in the memory, a wireless transceiver, an electronic lock selectively coupling the outer transverse member of the outer assembly to the inner transverse member of the inner assembly at a plurality of different positions for varying a transverse member overlap formed by the coupling of the inner transverse member with the outer transverse member and an overlap length of the transverse member overlap and a total transverse member length formed by the slidably coupling of the inner transverse member and outer transverse member responsive to the electronic lock;
wherein the wireless transceiver and the motor are each operatively coupled to the controller, the wireless transceiver configured for receiving a user code from a remote wireless device, the controller configured for comparing the received user code with stored unlock code and generating an unlock command responsive to a successful comparing, the electronic lock being responsive to the unlock command and enabling the varying of the transverse length of the combined inner and outer transverse members to expand a distance between the outer wheel clamping member and the inner wheel clamping member enabling the removal of the assembly from the wheel.

91. The assembly of claim 90, wherein the controller is configured to receive a user lock input to generate an assembly lock command to the electronic lock, the electronic lock responsive to the lock command and enabling a reduction in the transverse length of the combined inner and outer transverse members to reduce the distance between the outer wheel clamping member and the inner wheel clamping member.

92. The assembly of claim 90 wherein the inner wheel clamping member is selectively attachable to the inner transverse member, further comprising a manual locking assembly selectively fixedly securing the inner wheel clamping member to the inner transverse member.

93. The assembly of claim 92, further including a transverse length sensor positioned to detect the total transverse length and coupled to the controller to provide a detection of the transverse length to the controller, the controller configured to control the operation of the electronic responsive to the detection.

94. The assembly of claim 90, further including a transverse reduction pressure sensor to detect an amount of pressure applied during the reduction process and provide the detected pressure to the controller, the controller configured to compare the detected pressure with a predetermined maximum pressure and to terminate the generation of the transverse length reduction command to the electronic lock responsive to the detection.

95. The assembly of claim 90, further comprising a motion or pressure sensor positioned on the assembly configured to detect an amount of external motion or external pressure being applied to the assembly when the assembly is in a locked mode, the motion sensor coupled to the controller, and an audio generator operatively coupled to the controller, wherein the controller is configured to receive the detected amount of the motion from the motion sensor, compare the received detected amount of motion to an alarm threshold motion threshold as stored in the memory, and to generate an audible alarm over the audio generator responsive thereto.

96. The assembly of claim 90 wherein the wireless transceiver is either a Wi-Fi or Bluetooth transceiver configured for using encrypted messaging for receiving the unlock code, only from a locally positioned mobile device, and wherein the outer assembly includes a user interface coupled to the controller to receive a manual wake-up input from a user and provides a wake-up instruction to the controller for activating the controller and the transceiver, wherein the transceiver is responsive thereto and wirelessly transmit the access point security certification message prompting for entry of a security key, wherein the wireless transceiver is configured to receive a user security key response to the access point security certification message and provide the received security key as the user code to the controller responsive to the received access point security certification message.
